(19) United States
(12) Patent Application Publication
(10) Pub. No.: US 2024/0034071 A1
(43) Pub. Date: Feb. 1, 2024

(54) INKJET RECORDING DEVICE AND INKJET RECORDING METHOD

(71) Applicant: KYOCERA CORPORATION, Kyoto-shi, Kyoto (JP)

(72) Inventors: Daisuke ETO, Kyoto (JP); Masahiro HIGASHITANI, Kyoto (JP); Hiroatsu TAMAI, Kyoto (JP); Masaaki MARUTA, Kyoto (JP); Tomoya HOTANI, Kyoto (JP)

(21) Appl. No.: 18/254,381

(22) PCT Filed: Nov. 24, 2021
(86) PCT No.: PCT/JP2021/043014

§ 371 Date: May 25, 2023

(30) Foreign Application Priority Data
Nov. 30, 2020 (JP) 2020-198122

(51) Int. Cl. B41J 2/21; B41J 25/00

(52) U.S. Cl. CPC B41J 2/2117; B41J 25/001

(57) ABSTRACT

An inkjet recording device includes a conveyance unit, a carriage, a plurality of ink head lines, a preprocessing head, and a postprocessing head. The preprocessing head ejects a preprocessing solution. The postprocessing head ejects a postprocessing solution. In a case where a head arranged closest to one end in a main scanning direction is defined as a one-end side head, a head arranged closest to the other end is defined as an other-end side head, a distance from the one-end side head to the other-end side head in the main scanning direction is defined as LC, a distance from the one-end side head to the preprocessing head in the main scanning direction is defined as B1, and a distance from the one-end side head to the postprocessing head in the main scanning direction is defined as B2, a relationship of ½≤(B1+B2)/LC≤3/2 is satisfied.

### TECHNICAL FIELD

The present disclosure relates to an inkjet recording device including an ink head mounted on a carriage that moves in a main scanning direction, and an inkjet recording method thereof.

### BACKGROUND ART

An inkjet recording device such as an inkjet printer includes an ink head that ejects ink for image formation toward a recording medium. For example, in a case where a recording medium is a fiber sheet such as a woven fabric or a knitted fabric, or a plastic sheet, it may be necessary to apply a preprocessing solution and a postprocessing solution to the recording medium before and after ejecting ink toward the recording medium (e.g., Patent Literature 1). The preprocessing solution is, for example, a processing solution for improving fixability of ink to a recording medium and aggregability of an ink pigment. The postprocessing solution is, for example, a processing solution that enhances fastness of a printed image. In this case, the inkjet recording device includes a processing head that ejects the preprocessing solution and the postprocessing solution in addition to the ink head.

In a case where a recording medium has a wide width, the above described ink head and each processing head are mounted on a carriage that reciprocates in a main scanning direction. In recording processing, the recording medium is intermittently fed in a predetermined conveyance direction (sub-scanning direction), and the carriage is reciprocated in the main scanning direction while the recording medium is stopped. When the carriage moves, ink and a processing solution are ejected from the ink head and each processing head.

### CITATION LIST

### Patent Literature

Patent Literature 1: JP 2019-147307 A

### SUMMARY OF INVENTION

An inkjet recording device according to one aspect of the present disclosure includes a conveyance unit, a carriage, a plurality of ink head lines, a preprocessing head, and a postprocessing head. The conveyance unit is configured to convey a recording medium in a conveyance direction. The carriage is configured to reciprocate in a main scanning direction intersecting the conveyance direction. The plurality of ink head lines includes an even-numbered ink head lines and the plurality of ink head lines is located on the carriage and aligned in the conveyance direction. The preprocessing head is arranged on an upstream side of the plurality of ink head lines in the conveyance direction and configured to eject a non-coloring preprocessing solution. The postprocessing head is arranged on a downstream side of the plurality of ink head lines in the conveyance direction and configured to eject a non-coloring postprocessing solution. Each of the plurality of ink head lines includes a plurality of ink heads. The plurality of ink heads is arranged side by side in the main scanning direction and is configured to eject inks for image formation respectively. The preprocessing head and the postprocessing head are arranged to satisfy a relationship of Formula 1 in a case where among the plurality of ink heads, the preprocessing head, and the postprocessing head, a head arranged closest to one end in the main scanning direction is defined as a one-end side head, a head arranged closest to another end is defined as an other-end side head, a distance from the one-end side head to the other-end side head in the main scanning direction is defined as LC, a distance from the one-end side head to the preprocessing head in the main scanning direction is defined as B1, and a distance from the one-end side head to the postprocessing head in the main scanning direction is defined as B2.

½≤(B1+B2)/LC≤3/2 (Formula 1)

An inkjet recording device according to another aspect of the present disclosure includes a conveyance unit, a carriage, one ink head line or a plurality of ink head lines, a preprocessing head, and a postprocessing head. The conveyance unit is configured to convey a recording medium in a conveyance direction. The carriage is configured to reciprocate in a main scanning direction intersecting the conveyance direction. The one ink head line is located on the carriage at a position in the conveyance direction. The plurality of ink head lines includes an odd-numbered ink head lines and the plurality of ink head lines is located on the carriage and aligned in the conveyance direction. The preprocessing head is arranged on an upstream side of the one or plurality of ink head lines in the conveyance direction and configured to eject a non-coloring preprocessing solution. The postprocessing head is arranged on a downstream side of the one or plurality of ink head lines in the conveyance direction and configured to eject a non-coloring postprocessing solution. Each of the one or plurality of ink head lines includes a plurality of ink heads. The plurality of ink heads is arranged side by side in the main scanning direction and configured to eject inks for image formation respectively. The preprocessing head and the postprocessing head are arranged to satisfy a relationship of Formula 2 in a case where among the plurality of ink heads, the preprocessing head, and the postprocessing head, a head arranged closest to one end in the main scanning direction is defined as a one-end side head, a head arranged closest to another end is defined as an other-end side head, a distance from the one-end side head to the other-end side head in the main scanning direction is defined as LC, a distance from the one-end side head to the preprocessing head in the main scanning direction is defined as B1, and a distance from the one-end side head to the postprocessing head in the main scanning direction is defined as B2.

|(B1−B2)/LC|≤½ (Formula 2)

An inkjet recording method according to another aspect of the present disclosure is an inkjet recording method of an inkjet recording device. The inkjet recording device includes a conveyance unit, a carriage, one ink head line or a plurality of ink head lines, a preprocessing head, and a postprocessing head. The conveyance unit is configured to convey a recording medium in a conveyance direction. The carriage is configured to reciprocate in a main scanning direction intersecting the conveyance direction. The one ink head line is located on the carriage at a position in the conveyance direction. The plurality of ink head lines are located on the carriage and aligned in the conveyance direction. The preprocessing head is arranged on an upstream side of the one or plurality of ink head lines in the conveyance direction and configured to eject a non-coloring preprocessing solution. The postprocessing head is arranged on a downstream side of the one or plurality of ink head lines in the conveyance direction and configured to eject a non-coloring postprocessing solution. Each of the one or plurality of ink head lines includes a plurality of ink heads. The plurality of ink heads is arranged side by side in the main scanning direction and is configured to eject inks for image formation respectively. The inkjet recording method includes: arranging the preprocessing head and the postprocessing head so as to satisfy a relationship of Formula 1 in a case where among the plurality of ink heads, the preprocessing head, and the postprocessing head, a head arranged closest to one end in the main scanning direction is defined as a one-end side head, a head arranged closest to another end is defined as an other-end side head, a distance from the one-end side head to the other-end side head in the main scanning direction is defined as LC, a distance from the one-end side head to the preprocessing head in the main scanning direction is defined as B1, and a distance from the one-end side head to the postprocessing head in the main scanning direction is defined as B2, ½≤(B1+B2)/LC≤3/2 . . . (Formula 1); ejecting the preprocessing solution from the preprocessing head to a recording region on the recording medium while moving the carriage in a first direction in the main scanning direction; feeding the recording medium in the conveyance direction, and ejecting the ink from the ink head to the recording region received the ejected preprocessing solution while moving the carriage in the main scanning direction; and further feeding the recording medium in the conveyance direction, and ejecting the postprocessing solution from the postprocessing head to the recording region received the ejected ink while moving the carriage in a second direction opposite to the first direction in the main scanning direction.

Further, an inkjet recording method according to yet another aspect of the present disclosure is an inkjet recording method of an inkjet recording device. The inkjet recording device includes a conveyance unit, a carriage, one ink head line or a plurality of ink head lines, a preprocessing head, and a postprocessing head. The conveyance unit is configured to convey a recording medium in a conveyance direction. The carriage is configured to reciprocate in a main scanning direction intersecting the conveyance direction. The one ink head line is located on the carriage at a position in the conveyance direction. The plurality of ink head lines are located on the carriage and aligned in the conveyance direction. The preprocessing head is arranged on an upstream side of the one or plurality of ink head lines in the conveyance direction and configured to eject a non-coloring preprocessing solution. The postprocessing head is arranged on a downstream side of the one or plurality of ink head lines in the conveyance direction and configured to eject a non-coloring postprocessing solution. Each of the one or plurality of ink head lines includes a plurality of ink heads. The plurality of ink heads is arranged side by side in the main scanning direction and configured to eject inks for image formation respectively. The inkjet recording method includes: arranging the preprocessing head and the postprocessing head so as to satisfy a relationship of Formula 2 in a case where among the plurality of ink heads, the preprocessing head, and the postprocessing head, a head arranged closest to one end in the main scanning direction is defined as a one-end side head, a head arranged closest to another end is defined as an other-end side head, a distance from the one-end side head to the other-end side head in the main scanning direction is defined as LC, a distance from the one-end side head to the preprocessing head in the main scanning direction is defined as B1, and a distance from the one-end side head to the postprocessing head in the main scanning direction is defined as B2, |(B1−B2)/LC|≤½ . . . (Formula 2); ejecting the preprocessing solution from the preprocessing head to a recording region on the recording medium while moving the carriage in a first direction in the main scanning direction; feeding the recording medium in the conveyance direction, and ejecting the ink from the ink head to the recording region received the ejected preprocessing solution while moving the carriage in the main scanning direction; and further feeding the recording medium in the conveyance direction, and ejecting the postprocessing solution from the postprocessing head to the recording region received the ejected ink while moving the carriage in the first direction in the main scanning direction.

### BRIEF DESCRIPTION OF DRAWINGS

FIG. 1 is a perspective view illustrating an overall configuration of an inkjet printer according to an embodiment of the present disclosure.

FIG. 2 is a schematic cross-sectional view taken along line II-II in FIG. 1.

FIG. 3 is an enlarged perspective view of a carriage illustrated in FIG. 1.

FIG. 4 is a schematic view illustrating a serial printing method adopted in the present embodiment.

FIG. 5A is a schematic view illustrating a printing state in a forward path and a backward path of the carriage.

FIG. 5B is a schematic view illustrating a printing state in the forward path and the backward path of the carriage.

FIG. 6 is a plan view schematically illustrating head arrangement according to Example 1, the view showing arrangement of an ink head and a processing head in the carriage illustrated in FIG. 3.

FIG. 7 is a schematic view for explaining landing time of a preprocessing solution, ink, and a postprocessing solution at a point P on a recording medium.

FIG. 8 is a plan view of a carriage showing head arrangement according to Example 2.

FIG. 9 is a plan view of a carriage showing head arrangement according to Example 3.

FIG. 10 is a plan view of a carriage showing head arrangement according to Example 4.

FIG. 11 is a plan view of a carriage showing head arrangement according to Example 5.

FIG. 12 is a plan view of a carriage showing head arrangement according to Example 6.

FIG. 13 is a schematic view for explaining landing time of the preprocessing solution, the ink, and the postprocessing solution at the point P on the recording medium.

FIG. 14 is a plan view of a carriage showing head arrangement according to Example 7.

FIG. 15 is a plan view of a carriage showing head arrangement according to Example 8.

FIG. 16 is a plan view of a carriage showing head arrangement according to Example 9.

FIG. 17 is a plan view of a carriage showing head arrangement according to Example 10.

FIG. 18 is a plan view of a carriage showing head arrangement according to Example 11.

FIG. 19 is a plan view of a carriage showing head arrangement according to Example 12.

FIG. 20 is a plan view of a carriage showing head arrangement according to Example 13.

FIG. 21 is a plan view of a carriage showing head arrangement according to Example 14.

FIG. 22 is a plan view of a carriage showing head arrangement according to Example 15.

FIG. 23 is a plan view of a carriage showing head arrangement according to Example 16.

FIG. 24 is a plan view of a carriage showing head arrangement and sub-tank arrangement according to Example 17.

FIG. 25A is a schematic view for explaining a case where the recording media is conveyed at different conveyance pitches.

FIG. 25B is a schematic view for explaining a case where the recording media is conveyed at a different conveyance pitch.

FIG. 26 is a plan view of a carriage showing head arrangement according to Comparative Example 1 to be compared with the present disclosure.

FIG. 27 is a plan view of a carriage showing head arrangement according to Comparative Example 2 to be compared with the present disclosure.

### DESCRIPTION OF EMBODIMENT

In the following, an embodiment of the present disclosure will be described with reference to the drawings. In the present embodiment, as a specific example of an inkjet recording device, there will be illustrated an inkjet printer including an ink head that ejects ink for image formation on a wide and long recording medium. The inkjet printer of the present embodiment is suitable for digital textile printing in which images such as characters and patterns are printed on a recording medium made of fabric such as woven fabric and knitted fabric by an inkjet method. As a matter of course, the inkjet recording device according to the present disclosure is also applicable for printing various inkjet images on a recording medium such as a paper sheet or a resin sheet.

[Overall Configuration of Inkjet Printer]

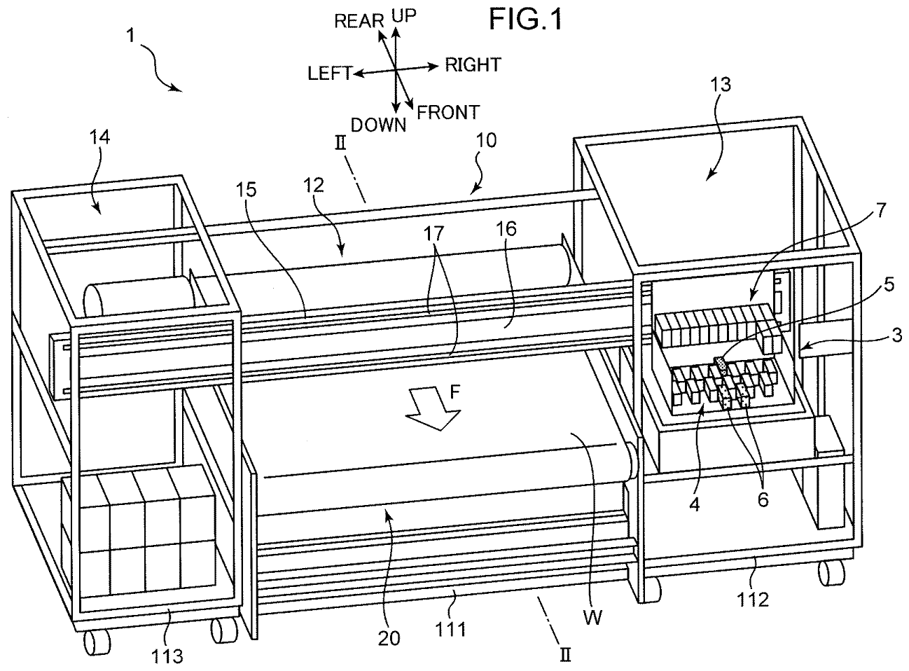

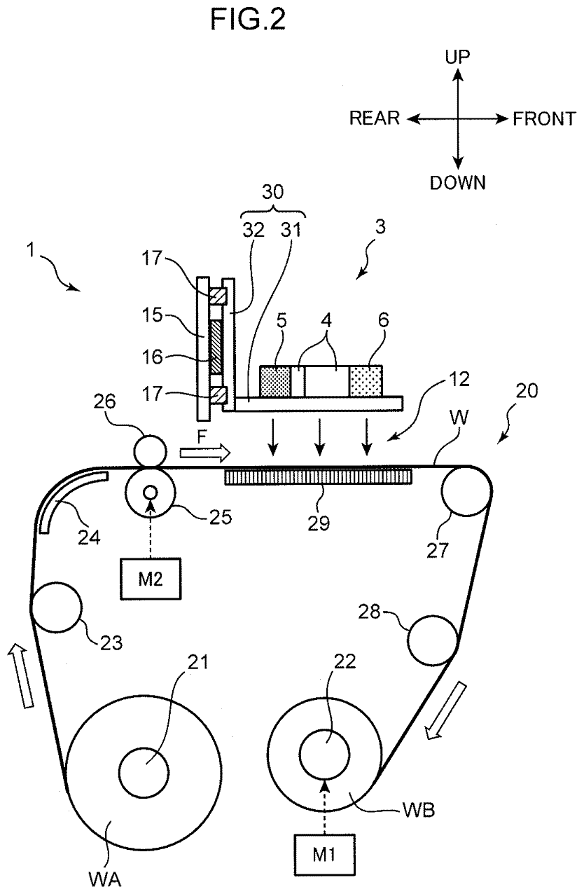

FIG. 1 is a perspective view showing an overall configuration of an inkjet printer 1 according to the one embodiment of the present disclosure, and FIG. 2 is a schematic cross-sectional view taken along line II-II of FIG. 1. The inkjet printer 1 is a printer that prints an image on a wide and long workpiece W (recording medium) by an inkjet method, and includes a device frame 10, and a workpiece conveyance unit 20 (conveyance unit) and a carriage 3 incorporated in the device frame 10. In the present embodiment, a left-right direction is a main scanning direction at the time of printing on the workpiece W, and a direction from the rear toward the front is a sub-scanning direction (conveyance direction F of the workpiece W).

The device frame 10 forms a frame for mounting various constituent members of the inkjet printer 1. The workpiece conveyance unit 20 is a mechanism that intermittently feeds the workpiece W so that the workpiece W advances, in a printing region where inkjet printing processing is executed, in the conveyance direction F from the rear toward the front. The carriage 3 has mounted thereon an ink head 4, a preprocessing head 5, a postprocessing head 6, and a sub-tank 7, and reciprocates in the left-right direction during the inkjet printing processing.

The device frame 10 includes a center frame 111, a right frame 112, and a left frame 113. The center frame 111 forms a frame for mounting various constituent members of the inkjet printer 1, and has a left-right width corresponding to the workpiece conveyance unit 20. The right frame 112 and the left frame 113 stand on the right and left of the center frame 111, respectively. Between the right frame 112 and the left frame 113 is a printing area 12 in which printing processing is executed on the workpiece W.

The right frame 112 forms a maintenance area 13. The maintenance area 13 is an area where the carriage 3 is retracted when the printing processing is not executed. In the maintenance area 13, cleaning processing, purge processing, and the like of nozzles (ejection holes) of the ink head 4, the preprocessing head 5, and the postprocessing head 6 are executed, and a cap is fitted thereto. The left frame 113 forms a turnaround area 14 of the carriage 3. The turnaround area 14 is a region where the carriage 3 that has main-scanned the printing area 12 from the right side to the left side in the printing processing temporarily enters when executing main scanning in a reverse direction.

A carriage guide 15 for causing the carriage 3 to reciprocate in the left-right direction is assembled on an upper side of the device frame 10. The carriage guide 15 is a flat plate-shaped member elongated in the left-right direction, and is arranged above the workpiece conveyance unit 20. A timing belt 16 (moving member) is assembled to the carriage guide 15 so as to be able to circulate in the left-right direction (the main scanning direction). The timing belt 16 is an endless belt, and is driven to circulate in the left direction or the right direction by a drive source (not illustrated).

The carriage guide 15 is provided with a pair of upper and lower guide rails 17 so as to extend in parallel in the left-right direction, the upper and lower guide rails being holding members that hold the carriage 3. The carriage 3 is engaged with the guide rails 17. In addition, the carriage 3 is fixed to the timing belt 16. The carriage 3 moves in the left direction or the right direction along the carriage guide 15 while being guided by the guide rails 17 as the timing belt 16 circulates in the left direction or the right direction.

With reference mainly to FIG. 2, the workpiece conveyance unit 20 includes a feed roller 21 that draws out the workpiece W before printing and a take-up roller 22 that winds up the workpiece W after printing. The feed roller 21 is arranged at a lower rear part of the device frame 10, and is a winding shaft of a feed roll WA which is a winder of the workpiece W before printing. The take-up roller 22 is arranged at a lower front part of the device frame 10, and is a winding shaft of a winding roll WB which is a winder of the workpiece W after the printing processing. The take-up roller 22 is provided with a first motor M1 that rotationally drives the take-up roller 22 around an axis to execute winding operation of the workpiece W.

A path provided between the feed roller 21 and the take-up roller 22 and passing through the printing area 12 is a conveyance path of the workpiece W. On the conveyance path, a first tension roller 23, a workpiece guide 24, a conveyance roller 25, a pinch roller 26, a turnaround roller 27, and a second tension roller 28 are arranged in order from an upstream side. The first tension roller 23 applies a predetermined tension to the workpiece W on an upstream side of the conveyance roller 25. The workpiece guide 24 changes the conveyance direction of the workpiece W from upward to a front direction to bring the workpiece W into the printing area 12.

The conveyance roller 25 is a roller that generates a conveyance force for intermittently feeding the workpiece W in the printing area 12. The conveyance roller 25 is rotationally driven around an axis by a second motor M2 to intermittently convey the workpiece W in the front direction (conveyance direction F) so that the workpiece W passes through the printing area 12 (image forming position) opposed to the carriage 3. The pinch roller 26 is arranged so as to be opposed to the conveyance roller 25 from above, and forms a conveyance nip portion with the conveyance roller 25.

The turnaround roller 27 changes the conveyance direction of the workpiece W having passed through the printing area 12 from the front direction to downward, and guides the workpiece W after the printing processing to the take-up roller 22. The second tension roller 28 applies a predetermined tension to the workpiece W on a downstream side of the conveyance roller 25. A platen 29 is arranged in the printing area 12 below the conveyance path of the workpiece W.

The carriage 3 reciprocates in the main scanning direction (the left-right direction in the present embodiment) intersecting (orthogonal to, in the present embodiment) the conveyance direction F in a state of being cantilevered by the guide rails 17. The carriage 3 includes a carriage frame 30, and the ink head 4, the preprocessing head 5, the postprocessing head 6, and the sub-tank 7 mounted on the carriage frame 30. The carriage frame 30 includes a head support frame 31 and a back frame 32 (engagement portion).

The head support frame 31 is a horizontal plate that holds the above-described heads 4 to 6. The back frame 32 is a vertical plate extending upward from a rear end edge of the head support frame 31. As described above, the timing belt 16 is fixed to the back frame 32. In addition, the guide rails 17 are engaged with the back frame 32. In other words, in the present embodiment, the back frame 32 is the engagement portion held by the guide rails 17 in a cantilevered state. The head support frame 31 is a horizontal plate whose rear end side is cantilevered by the guide rail 17 via the engagement portion.

The cantilevered state represents a state in which the engagement portion (back frame 32) is present in the carriage 3 only from the center to one side of the carriage 3, an upstream side or a downstream side, in the conveyance direction F, and no other engagement portion is present on the side opposite to the side where the engagement portion is present. The engagement portion is a portion held by the guide rails 17 which are the holding members. The engagement portion may be further arranged in a range other than the range in which the ink head 4 and the processing heads are arranged in the conveyance direction F. Specifically, the engagement portion may be arranged only on an upstream side or only on a downstream side with respect to the range in which the ink head 4 and the processing heads are arranged in the conveyance direction F.

[Details of Carriage]

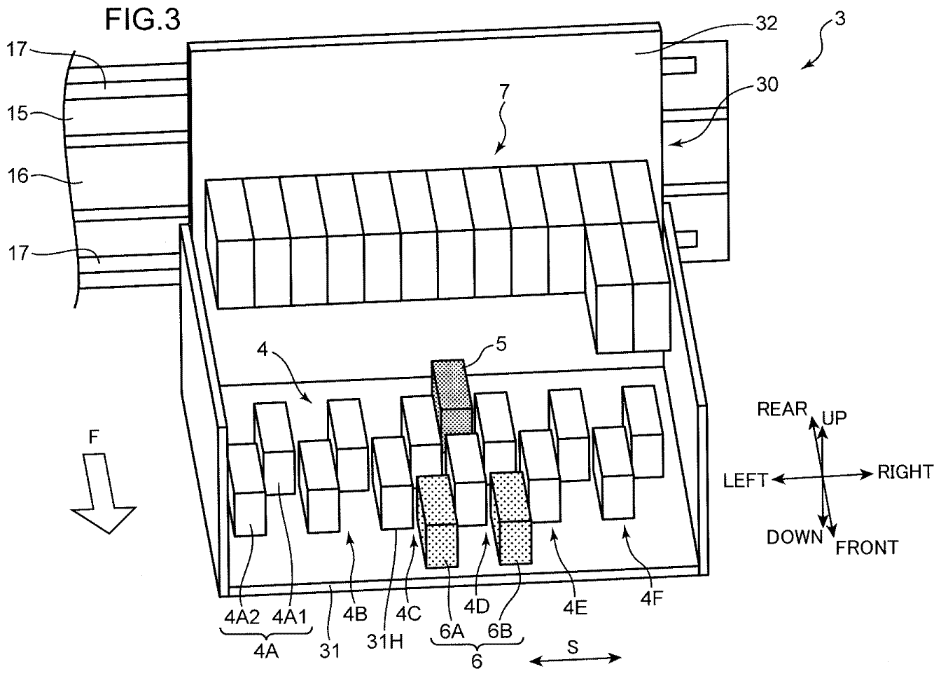

The carriage 3 will be further described. FIG. 3 is an enlarged perspective view of the carriage 3 illustrated in FIG. 1. FIG. 3 illustrates the conveyance direction F (sub-scanning direction) of the workpiece W and a main scanning direction S which is a moving direction of the carriage 3. FIG. 3 shows an example in which a plurality of the ink heads 4 that eject ink for image formation to the workpiece W, the preprocessing head 5 and the postprocessing head 6 that eject non-coloring processing solutions, and a plurality of the sub-tanks 7 that supply the ink and the processing solutions to these heads 4 to 6 are mounted on the carriage 3.

Each of the ink heads 4 includes a large number of nozzles (ink ejection holes) that eject ink droplets by an ejection method such as a piezoelectric method using a piezoelectric element or a thermal method using a heating element, and an ink passage that guides the ink to the nozzles. As the ink, for example, an aqueous pigment ink containing an aqueous solvent, a pigment, and a binder resin can be used. The plurality of ink heads 4 in the present embodiment include first to sixth ink heads 4A to 4F that respectively eject inks of six different colors. For example, the first ink head 4A ejects an orange (second color) ink, the second ink head 4B ejects a green (second color) ink, the third ink head 4C ejects a yellow (first color) ink, the fourth ink head 4D ejects a red (first color) ink, the fifth ink head 4E ejects a blue (first color) ink, and the sixth ink head 4F ejects a black (second color) ink.

The ink heads 4A to 4F of the respective colors are mounted on the head support frame 31 of the carriage 3 so as to be aligned in the main scanning direction S. Each of the ink heads 4A to 4F for the respective colors has two heads. For example, the first ink head 4A is configured with an upstream side head 4A1 arranged on the upstream side in the conveyance direction F, and a downstream side head 4A2 arranged at a position downstream of the upstream side head 4A1 and shifted to the left side in the main scanning direction S. The same applies to the ink heads 4B to 4F of the other colors. The respective upstream side heads of the ink heads 4B to 4F are aligned in the main scanning direction S at the same position as the upstream side head 4A1 in the conveyance direction F, and the respective downstream side heads are aligned in the main scanning direction S at the same position as the downstream side head 4A2 in the conveyance direction F.

The preprocessing head 5 and the postprocessing head 6 are arranged at positions different from the ink head 4 in the conveyance direction F. The preprocessing head 5 is arranged upstream of the ink head 4 in the conveyance direction F. FIG. 3 shows the example in which one preprocessing head 5 is arranged in the vicinity of the center of an array of the ink heads 4. Similarly, the postprocessing head 6 is arranged downstream of the ink head 4 in the conveyance direction F. FIG. 3 shows the example in which two postprocessing heads 6A and 6B (a plurality of the processing heads) are arranged to be aligned in the main scanning direction S in the vicinity of the center of the array of the ink heads 4. Various arrangement patterns of the ink head 4, the preprocessing head 5, and the postprocessing head 6 in the carriage 3 will be detailed in Examples 1 to 17 to be described later.

Note that as used in the above description, a series of the heads along the main scanning direction S configured by the ink head 4 and the postprocessing head 6 is referred to as a line of the heads or simply as a line. The line of the heads may include the preprocessing head 5. A series of the heads along the conveyance direction F configured by the ink head 4, the preprocessing head 5, and the postprocessing head 6 is referred to as a row of the heads or simply as a row.

The preprocessing head 5 ejects a preprocessing solution for subjecting predetermined preprocessing to the workpiece W. The preprocessing solution is ejected from the preprocessing head 5 to a position of the workpiece W to which no ink has yet been ejected from the ink head 4. The preprocessing solution is a non-coloring processing solution that does not develop color even if it adheres to the workpiece W, and is, for example, a processing solution that exhibits a function of enhancing fixability of ink to the workpiece W, aggregability of an ink pigment, and the like. As such a preprocessing solution, a processing solution obtained by blending a binder resin in a solvent, a processing solution obtained by blending a cationic resin positively charged in a solvent, or the like can be used.

The postprocessing head 6 ejects a postprocessing solution for subjecting predetermined postprocessing to the workpiece W to which ink is adhered. The postprocessing solution is ejected from the postprocessing head 6 to a position of the workpiece W to which ink has been ejected from the ink head 4. Similarly, the postprocessing solution is a non-coloring processing solution that does not develop color even if it adheres to the workpiece W, and is a processing solution that exhibits a function of enhancing fixability and fastness (resistance to rubbing and scraping) of an ink image printed on the workpiece W by the ink head 4. As such a postprocessing solution, a silicone-based processing solution or the like can be used. Note that the postprocessing solution and the preprocessing solution are different processing solutions. Specifically, the postprocessing solution and the preprocessing solution contain different components.

Here, the non-coloring processing solution represents a processing solution that prevents a person from recognizing, with naked eyes, color development when the solution is printed alone on a recording medium. The color here includes black, white, gray, and the like having zero saturation. Although the non-coloring processing solution is basically a transparent liquid, for example, when one liter of the processing solution is viewed in a liquid state, the solution may appear slightly white or the like, not completely transparent. Since such color is very light, when the color is printed alone on a recording medium, a person cannot recognize with naked eyes that the color is developed. Although when a recording medium is printed with some type of processing solution alone, the recording medium might have a change such as generation of gloss, such a state is not considered color development.

In the present embodiment, the preprocessing solution and the postprocessing solution may be ejected onto substantially the entire surface of the workpiece W, or the preprocessing solution and the postprocessing solution may be selectively ejected in accordance with an image to be printed, similarly to ink.

Subsequently, a case where the preprocessing solution and the postprocessing solution are selectively ejected will be described. As described above, the preprocessing solution, the ink, and the postprocessing solution are ejected in this order to a part of the workpiece W where the color is printed in accordance with an image. In this case, the ink may be of one color or of a plurality of colors. Basically, neither the preprocessing solution nor the postprocessing solution is ejected to a part where no color is printed, i.e., a part to which no ink is ejected. In order to adjust image quality of an image to be printed, texture of the workpiece W, and the like, a part of ejection of the preprocessing solution and the postprocessing solution may be selected in a manner different from that of ejection of the ink.

Openings 31H are provided at head arrangement positions on the head support frame 31. The ink heads 4A to 4F, the preprocessing head 5, and the postprocessing head 6 are assembled to the head support frame 31 so as to be fitted into the respective openings 31H. A nozzle arranged on a lower end surface of each of the heads 4, 5, and 6 is exposed from each opening 31H.

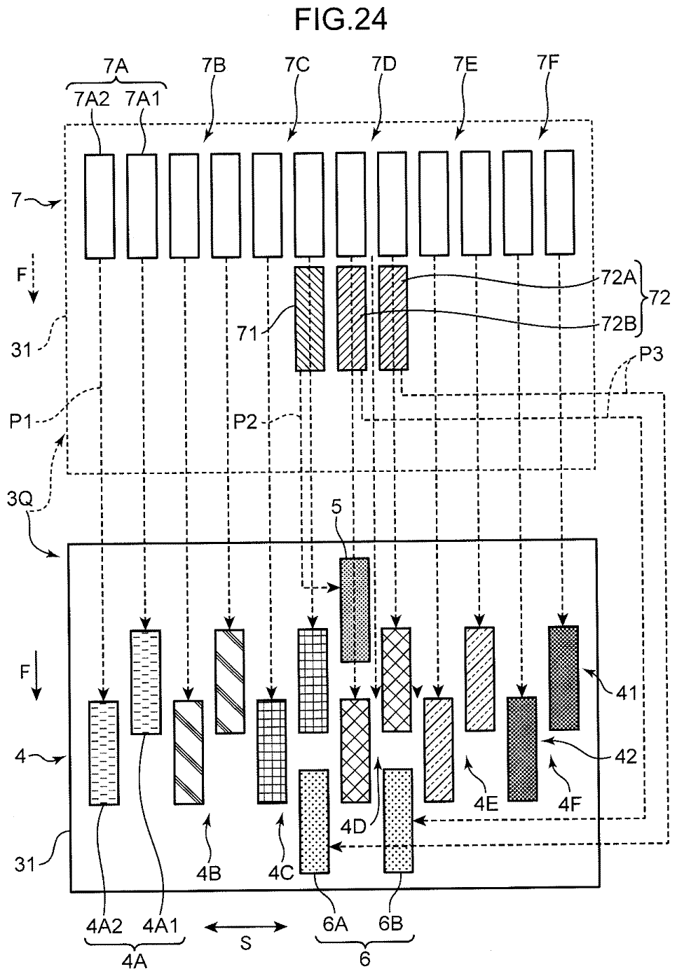

The sub-tank 7 is supported in the carriage 3 at a position above the heads 4, 5, and 6 via a holding frame (not illustrated). The sub-tank 7 is provided corresponding to each of the heads 4, and 6. Ink or a processing solution (not illustrated) is supplied to each sub-tank 7 from a cartridge or a main tank in which the ink and the processing solution are stored. Each sub-tank 7 supplies the ink or the processing solution to each of the heads 4, 5, and 6. Each of the sub-tanks 7 and the heads 4, 5, and 6 are connected by a pipeline (P1, P2, P3 illustrated in FIG. 24) not illustrated in FIG. 3.

As described in the foregoing, the inkjet printer 1 according to the present embodiment is an all-in-one printer in which the three types of heads, the ink head 4, the preprocessing head 5, and the postprocessing head 6 are mounted on one carriage 3. According to the inkjet printer 1, for example, in a printing step of executing inkjet printing on fabric in digital textile printing, a step of ejecting the preprocessing solution and a step of ejecting the postprocessing solution can be executed integrally. Therefore, a textile printing step can be simplified, and a textile printing device can be made compact.

[Printing Method]

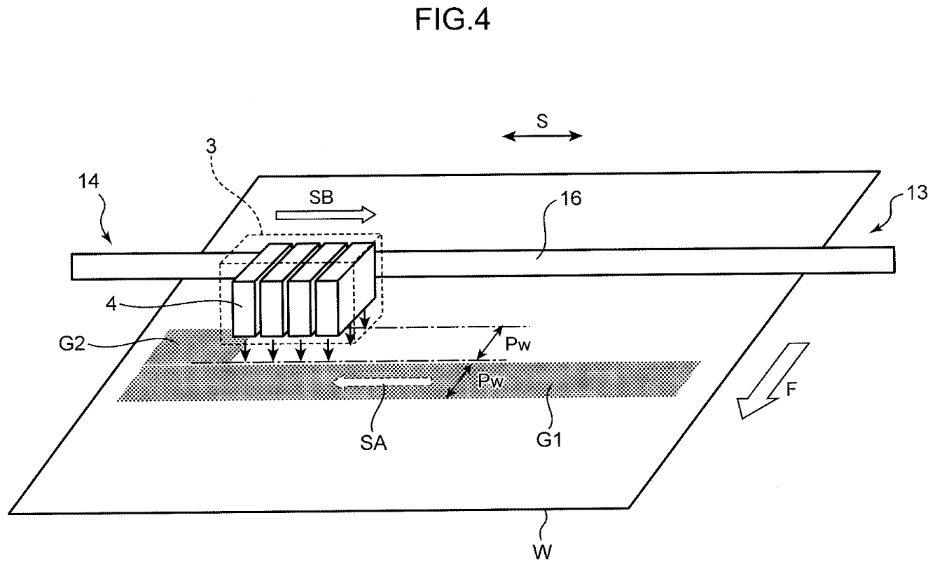

Subsequently, a printing method executed by the inkjet printer 1 according to the present embodiment will be described. The inkjet printer 1 performs the printing processing on the workpiece W by a serial printing method. FIG. 4 is a schematic view illustrating the serial printing method. In FIG. 4, the carriage 3 is simply drawn without the preprocessing head 5 and the postprocessing head 6.

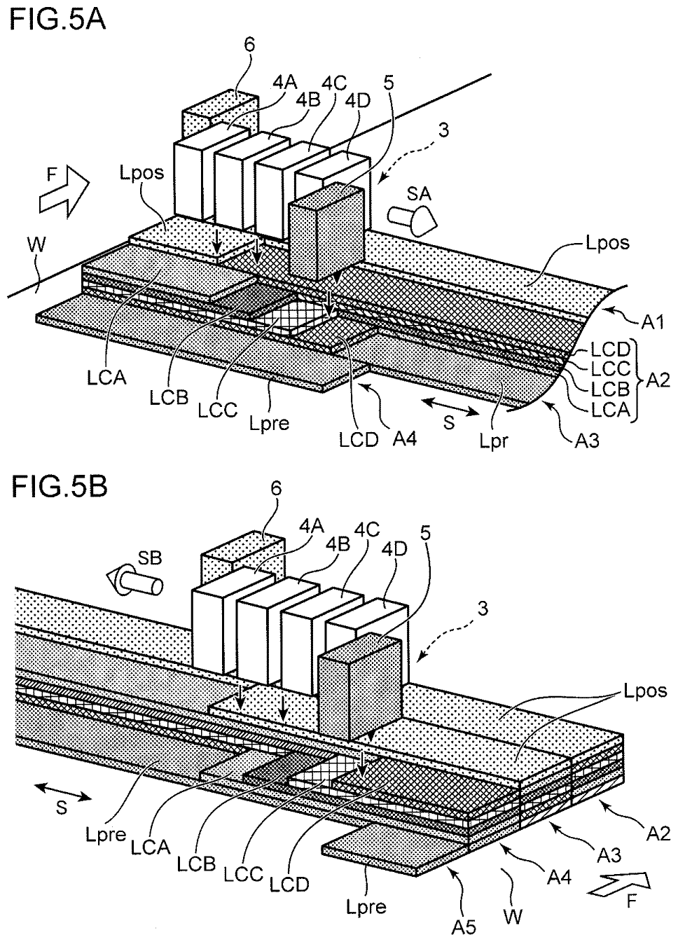

In a case where the workpiece W has a size with a large width, printing cannot be performed while continuously feeding the workpiece W. The serial printing method is a printing method of repeating reciprocating movement, in the main scanning direction S, of the carriage 3 on which the ink heads 4 of the respective colors are mounted and intermittent feeding of the workpiece W in the conveyance direction F. Here, it is assumed that the ink head 4 has a predetermined print width Pw in the conveyance direction F. The print width Pw is substantially equal to an array range of ink ejection nozzles of the ink heads 4. In FIG. 4, and FIG. 5A and FIG. 5B to be described below, a width of each head in the conveyance direction F and the print width Pw are drawn substantially equal. In practice, the width of each head in the conveyance direction F is larger than the print width Pw and the array range of the ejection nozzles.

FIG. 4 illustrates a state in which the carriage 3 has moved in a forward direction SA in the main scanning direction S and printing of a band-shaped image G1 having the print width Pw is completed. At the time of main scanning in the forward direction SA, the feeding of the workpiece W is stopped. After the band-shaped image G1 is printed, the workpiece W is fed in the conveyance direction F by a pitch corresponding to the print width Pw. At this time, the carriage 3 waits in the turnaround area 14 on a left end side. After the feeding of the workpiece W, the carriage 3 turns around in a backward direction SB along with reverse movement of the timing belt 16. The workpiece W is in a stopped state. Then, as illustrated in FIG. 4, the carriage 3 prints a band-shaped image G2 having the print width Pw on an upstream side of the band-shaped image G1 while moving in the backward direction SB. Hereinafter, the same operation is repeated.

FIG. 5A and FIG. 5B are schematic views illustrating a printing state in a forward path and a backward path of the carriage 3. Here, the ink head 4, the preprocessing head 5, and the postprocessing head 6 mounted on the carriage 3 are simply illustrated. The ink head 4 includes the first, second, third, and fourth ink heads 4A, 4B, 4C, and 4D for ejecting inks of first, second, third, and fourth colors different from each other. The first to fourth ink heads 4A to 4D are aligned in the main scanning direction S. The preprocessing head 5 is arranged upstream of the ink head 4 in the conveyance direction F, and the postprocessing head 6 is arranged downstream of the same. Similarly to the case described with reference to FIG. 4, the workpiece W is fed in the conveyance direction F at a time between the forward printing and the backward printing. A moving distance in the conveyance direction F at this time is an interval pitch (head pitch) between adjacent heads in the conveyance direction F. The moving distance is also the print width of each of the heads 4, 5, 6.

FIG. 5A illustrates a state in which while moving in the forward direction SA in the main scanning direction S, the carriage 3 is performing printing operation (forward main scanning). A region A4 on the workpiece W is a region to which the preprocessing head 5 mounted on a most upstream side of the carriage 3 is opposed. In the forward main scanning this time, a preprocessing layer Lpre is formed on the region A4 by the preprocessing solution ejected from the preprocessing head 5.

A region A3 is a region located downstream of the region A4 by one head pitch, and is a region to which the ink head 4 is opposed. On the region A3, the preprocessing layer Lpre has already been formed over the entire length in the main scanning direction by backward main scanning last time. In the forward main scanning this time, first, second, third, and fourth ink layers LCA, LCB, LCC, and LCD are formed on the preprocessing layer Lpre in the region A3 by the inks of the first to fourth colors sequentially ejected in the order of arrangement of the first to fourth ink heads 4A to 4D. Although in FIG. 5A, the fourth to first ink layers LCD to LCA are illustrated to be sequentially laminated for easy understanding, the ink layers are not actually laminated. Note that the above-described preprocessing layer Lpre and a postprocessing layer Lpos to be described later are not formed on the workpiece W.

A region A2 is a region located downstream of the region A3 by one head pitch, and is a region to which the postprocessing head 6 mounted on a most downstream side of the carriage 3 is opposed. On the region A2, the preprocessing layer Lpre by the forward main scanning last time and the first to fourth ink layers LCA to LCD by the backward main scanning last time have been already formed over the entire length in the main scanning direction. In the forward main scanning this time, the postprocessing layer Lpos is formed on the first to fourth ink layers LCA to LCD in the region A2 by the postprocessing solution ejected from the postprocessing head 6.

A region A1 is a region downstream of the region A2 by one head pitch, and is a region through which the carriage 3 has passed and the printing processing is completed. In other words, in the region A1, the preprocessing layer Lpre, the first to fourth ink layers LCA to LCD, and the postprocessing layer Lpos are formed over the entire length in the main scanning direction.

FIG. 5B illustrates a state in which after the forward main scanning shown in FIG. 5A is finished, the carriage 3 turns around to perform the backward main scanning while moving in the backward direction SB. Before the turnaround movement, the workpiece W is fed in the conveyance direction F by one head pitch. A region A5 on the workpiece W is a region located upstream of the region A4 by one head pitch, and is a region to which the preprocessing head 5 is opposed in the backward main scanning this time. The preprocessing layer Lpre is formed on the region A5 by the preprocessing solution ejected from the preprocessing head 5.

In the region A4 and the region A3, the first to fourth ink layers LCA to LCD and the postprocessing layer Lpos are formed on the existing layers, respectively. Specifically, in the region A4, the first to fourth ink layers LCA to LCD are formed on the preprocessing layer Lpre. In the region A3, the postprocessing layer Lpos is formed on the first to fourth ink layers LCA to LCD. The region A2 is a region where the printing processing is completed subsequently to the region A1.

The reason why the printing processing can be performed in both the forward main scanning and the backward main scanning as described above is that the preprocessing head 5 and the postprocessing head 6 are shifted with respect to the ink head 4 in the conveyance direction F. In a case where the preprocessing head 5, the ink head 4, and the postprocessing head 6 are aligned in the carriage 3 in this order in the main scanning direction S, printing processing enabling the preprocessing solution and the postprocessing solution to be landed in a desired landing order can be realized only in one of the forward main scanning and backward main scanning. In order to enable printing processing in two ways, a pair of the preprocessing head 5 and the postprocessing head 6 needs to be arranged on both sides of the array of the ink heads 4. In this case, a width of the carriage 3 in the main scanning direction S is increased. Since such arrangement is unnecessary in the present embodiment, the width of the carriage 3 in the main scanning direction S can be reduced.

When the ink heads 4 are set to have a plurality of lines, an amount of ink to be landed on the workpiece W can be increased. For example, when there are two lines of the ink heads 4, printing can be performed as follows. After the first to fourth ink layers LCA to LCD are formed by the ink head 4 in the first line as described above, the workpiece W is conveyed in the conveyance direction F by one head pitch, and the first to fourth ink layers LCA to LCD are formed by the ink head 4 in the second line. In this manner, ink with an amount for two layers can be printed on the workpiece W.

[Various Modes of Head Arrangement]

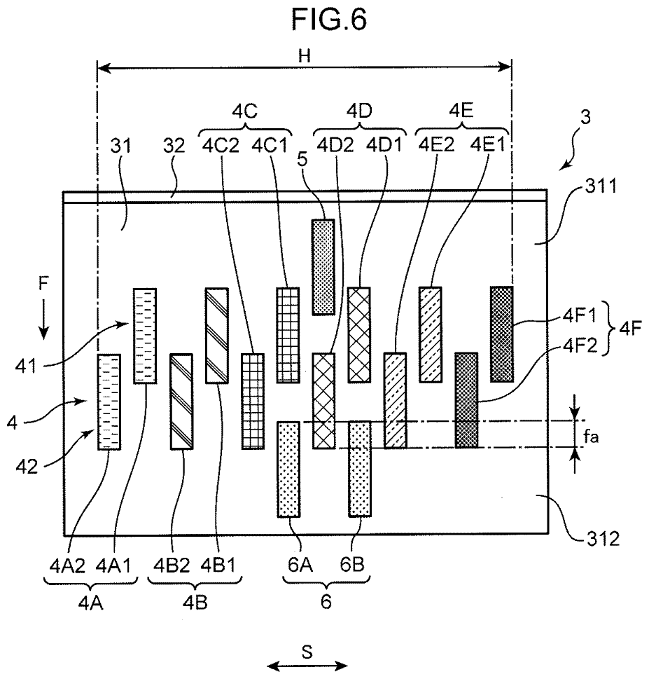

In the following, various arrangement examples of the ink head 4, the preprocessing head 5, and the postprocessing head 6 on the carriage 3 will be illustrated as Examples 1 to 17. Note that FIGS. 1 to 5A and 5B described above are for the purpose of describing the basic functions of the preprocessing head 5 and the postprocessing head 6, and detailed arrangement of the preprocessing head 5 and the postprocessing head 6 according to the present embodiment will be described below with reference to FIG. 6 and subsequent drawings.

### Example 1

FIG. 6 is a plan view schematically showing head arrangement according to Example 1. FIG. 6 is a view showing arrangement of the ink head 4, the preprocessing head 5, and the postprocessing head 6 (the plurality of processing heads) in the carriage 3 shown in FIG. 3. The carriage 3 is supported in the cantilevered state at the back frame 32 (engagement portion) by the guide rail 17. The back frame 32 is arranged on the upstream side in the conveyance direction F of the head support frame 31. In the conveyance direction F, a side of the head support frame 31 on which the back frame 32 is arranged is referred to as a proximal end side 311, and a side of the head support frame 31 opposite to the proximal end side 311 is referred to as a distal end side 312. As described above, on the head support frame 31 of the carriage 3, the first to sixth ink heads 4A to 4F that respectively eject the inks of the six different colors, the preprocessing head 5, and the postprocessing head 6 are mounted. Each of the ink heads 4A to 4F of the respective colors includes two unit heads (12 in total). While the number of the preprocessing heads 5 is one, two postprocessing heads 6 are provided.

Groups of the first to sixth ink heads 4A to 4F constituting the ink head 4 are arrayed so as to be aligned in the main scanning direction S in a central region in the conveyance direction F of the head support frame 31. The preprocessing head 5 is arranged, in a substantially central portion of the carriage 3 in the main scanning direction S, on the upstream side of the ink head 4 in the conveyance direction F, and on the proximal end side 311 of the head support frame 31. On the other hand, the postprocessing head 6 is arranged, in the substantially central portion of the carriage 3 in the main scanning direction S, on the downstream side of the ink head 4 in the conveyance direction F, and on the distal end side 312 of the head support frame 31. The preprocessing head 5 and the postprocessing head 6 are both arranged near a central portion of the head support frame 31 in the main scanning direction S.

The first ink head 4A includes the upstream side head 4A1, and the downstream side head 4A2 arranged downstream of the upstream side head 4A1. In other words, the upstream side head 4A1 and the downstream side head 4A2 are arrayed in the conveyance direction F. An arrangement position of the upstream side head 4A1 is a position closer to the proximal end side 311 in the central region of the head support frame 31. An arrangement position of the downstream side head 4A2 is a position closer to the distal end side 312 in the central region of the head support frame 31. The downstream side head 4A2 is arranged at a position shifted to one side (left side) in the main scanning direction S with respect to the upstream side head 4A1, and is arranged at a position partially overlapping with the upstream side head in the conveyance direction F. As a matter of course, the upstream side head 4A1 and the downstream side head 4A2 may be arrayed at the same position in the main scanning direction S (the position at which the heads are linearly aligned in the conveyance direction F). The arrangement of the present example, however, enables more reduction in a size of the carriage 3 in the conveyance direction F.

By arranging the ink heads 4 in this manner, the ink heads that eject one color are arranged in a cluster in the main scanning direction S. Specifically, all the ink heads 4 that are mounted on the carriage 3 to eject one color are arranged so as not to sandwich, in their middle in the main scanning direction S, the ink heads 4 that eject other colors. Furthermore, all the ink heads 4 that are mounted on the carriage 3 to eject one color may be arranged within a predetermined range, and the ink heads 4 that eject other colors may not be arranged within the range.

In a case where there is a difference in a printing state such as a landing position and an ejection amount between the two ink heads 4, the difference is more likely to stand out in a case of ejecting the same color than in a case of ejecting different colors by the two ink heads 4. Arranging the ink heads 4 that eject the same color in a cluster in the main scanning direction S makes printed image quality be hardly degraded even if there is a difference in a printing state between the ink heads 4.

The second to sixth ink heads 4B to 4F also include upstream side heads 4B1, 4C1, 4D1, 4E1, and 4F1 and downstream side heads 4B2, 4C2, 4D2, 4E2, and 4F2, respectively, which are similar to the upstream side head 4A1 and the downstream side head 4A2 described above. The upstream side heads 4A1 to 4F1 of the first to sixth ink heads 4A to 4F are aligned at the same position in the conveyance direction F and at predetermined intervals in the main scanning direction S. The downstream side heads 4A2 to 4F2 are also aligned at the same position in the conveyance direction F and at predetermined intervals in the main scanning direction S. As a result, a staggered arrangement mode is formed in which parts of the downstream side heads 4A2 to 4F2 are interposed between arrangement pitches of the upstream side heads 4A1 to 4F1, respectively.

In other words for the configuration of the ink head 4, the ink head 4 has a plurality of ink head lines mounted on the carriage 3 so as to be aligned in the conveyance direction F. Each of the plurality of ink head lines includes a plurality of ink heads that are arranged side by side in the main scanning direction S and eject inks for image formation. In the example shown in FIG. 6, the plurality of ink head lines includes a first ink head line 41 and a second ink head line 42. The ink heads included in the first ink head line 41 are the upstream side heads 4A1, 4B1, 4C1, 4D1, 4E1, and 4F1. The ink heads included in the second ink head line 42 are the downstream side heads 4A2, 4B2, 4C2, 4D2, 4E2, and 4F2.

The preprocessing head 5 is arranged so as to be partially interposed between a pair of adjacent ink heads in the main scanning direction S. Specifically, the preprocessing head 5 has a positional relationship having its downstream portion interposed between the upstream side head 4C1 of the third ink head 4C and the upstream side head 4D1 of the fourth ink head 4D.

The postprocessing head 6 includes a first postprocessing head 6A and a second postprocessing head 6B arranged side by side in the main scanning direction S. FIG. 6 shows the example in which the first postprocessing head 6A and the second postprocessing head 6B are arranged at the same position in the conveyance direction F and side by side at predetermined intervals in the main scanning direction S. The first postprocessing head 6A is arranged so as to have its upstream side portion interposed between the downstream side head 4C2 of the third ink head 4C and the downstream side head 4D2 of the fourth ink head 4D. The second postprocessing head 6B is arranged so as to have its upstream side portion interposed between the downstream side head 4D2 and the downstream side head 4E2 and is arranged at the same position as the upstream side head 4D1 in the main scanning direction S. With this arrangement, the first and second postprocessing heads 6A and 6B are set to have an arrangement relationship having an overlapping region fa with the downstream side heads 4C2, 4D2, and 4E2 in the conveyance direction F.

In the conveyance direction F, a width of each head is larger than the print width Pw and the array range of the ejection nozzles. Therefore, each head is arranged to have the overlapping region fa in order not to have a space between the print range Pw of the head in each line and the print range Pw of the head in an adjacent line.

Unless otherwise specified, in the drawings including FIG. 6, an interval between the heads adjacent to each other in the main scanning direction S (an interval between the centers of the heads) is the same. Similarly, an interval between adjacent heads in the conveyance direction F (an interval between the centers of the heads) is the same.

As a result of the head arrangement described above, the preprocessing head 5 and the postprocessing head 6 are arranged within a range of an arrangement width H of the ink head 4 in the main scanning direction S. The ink head 4 has the arrangement width H between the downstream side head 4A2 of the first ink head 4A and the upstream side head 4F1 of the sixth ink head 4F in the main scanning direction S. The preprocessing head 5 is arranged on the upstream side of the ink head 4 within the range of the arrangement width H, and the postprocessing head 6 is arranged on the downstream side of the ink head 4 within the range of the arrangement width H.

According to the head arrangement according to Example 1 described above, it is possible to increase ejection amounts of necessary ink and processing solution while reducing the size of the carriage 3. In other words, the preprocessing head 5 and the postprocessing head 6 are arranged at positions different from the ink head 4 in the conveyance direction F. With this configuration, a width of the carriage in the main scanning direction necessary for mounting the heads 4 to 6 can be shortened while arraying the ink heads 4A to 4F capable of ejecting ink of a necessary amount in the main scanning direction S and while enabling the printing processing in both the forward main scanning and the backward main scanning. Furthermore, the postprocessing head 6 is configured with the plurality of first and second postprocessing heads 6A and 6B, which are arranged side by side in the main scanning direction S. Therefore, even when an ejection amount of the postprocessing solution is insufficient with a single head, a necessary amount can be ejected by arranging the plurality of postprocessing heads 6A and 6B.

The first to sixth ink heads 4A to 4F include the upstream side heads 4A1 to 4F1 (the first ink head line 41) and the downstream side heads 4A2 to 4F2 (the second ink head line 42) arrayed in the conveyance direction F (the direction intersecting an array direction of the plurality of processing heads), respectively. Therefore, even if the number of the ink heads 4 is increased in order to increase the ejection amount of the ink of each color or to achieve multicoloring, it is possible to make the width of the carriage 3 in the main scanning direction be hardly increased.

The preprocessing head 5 and the postprocessing head 6 are arranged within the range of the arrangement width H of the first to sixth ink heads 4A to 4F in the main scanning direction S. Therefore, even when the preprocessing head 5 and the postprocessing head 6 are mounted on the carriage 3 in addition to the ink head 4, it is not necessary to extend the width of the carriage 3 in the main scanning direction. In other words, it is possible to make the width of the carriage 3 in the main scanning direction be hardly increased.

The preprocessing head 5 and the postprocessing head 6 are arranged so as to have a part thereof interposed between the array pitches of the first to sixth ink heads 4A to 4F. Focusing on the first postprocessing head 6A, a part of the first postprocessing head 6A is interposed between the pair of downstream side heads 4C2 and 4D2. Such staggered arrangement enables the ink head 4 and the processing heads 5 and 6 arranged at different positions in the conveyance direction F to be arranged at high density in the conveyance direction F. Accordingly, the width of the carriage 3 in the conveyance direction F can be reduced.

In the head arrangement of Example 1, one preprocessing head 5 is arranged on the upstream side of the ink head 4 in the conveyance direction F, and two postprocessing heads 6A and 6B are arranged on the downstream side. In other words, it is possible to provide the all-in-one inkjet printer 1 in which three kinds of heads for the preprocessing solution, the ink, and the postprocessing solution are mounted on one carriage 3. Furthermore, since the preprocessing head 5, the ink head 4, and the postprocessing head 6 are sequentially arranged in the conveyance direction F, the preprocessing solution, the ink, and the postprocessing solution can be ejected in a desired landing order in both the forward main scanning and the backward main scanning.

The carriage 3 has the back frame 32 (engagement portion) that is held in the cantilevered state by the guide rails 17 (holding members). The structure can be simplified by cantilevering the carriage 3 by the timing belt 16. In addition, cantilevering easily realizes a structure in which a downstream side of the carriage 3 is opened, and facilitates maintenance of the ink head 4 and the processing heads 5 and 6.

In thus cantilevered carriage 3, the preprocessing head 5 is arranged on the proximal end side 311 (the side close to the engagement portion) of the head support frame 31, and the postprocessing head 6 is arranged on the distal end side 312 (the side far from the engagement portion). Unlike the proximal end side 311 close to the back frame 32 fixed to the timing belt 16, it is assumed that positional accuracy inevitably decreases on the distal end side 312 which is a free end. However, on the distal end side 312, there is mounted the postprocessing head 6 that is not relatively required to be highly severe in ejection accuracy. Since the postprocessing solution serves for coating an ink image printed on the workpiece W, even when the landing position deviates, a relative degree of influence on image quality can be reduced as compared with a case where the preprocessing solution has the same degree of landing position deviation. Accordingly, even when the cantilevered carriage 3 is used, it is possible to make image quality hardly deteriorate.

<Problems in Head Arrangement>

As described above, when the preprocessing head 5 that ejects the preprocessing solution and the postprocessing head 6 that ejects the postprocessing solution are mounted on the carriage 3 in addition to the ink head 4, and the preprocessing solution, the ink, and the postprocessing solution are sequentially ejected to the workpiece W as the carriage 3 reciprocates in the main scanning direction, there occurs a problem that time from landing of the preprocessing solution to landing of the postprocessing solution varies depending on an image position in the main scanning direction S, resulting in causing image quality to be liable to vary on the workpiece W.

For example, in a case of using a preprocessing solution that enhances aggregability of an ink pigment, color development becomes deeper as the time from the landing of the preprocessing solution to the landing of the ink becomes longer. Furthermore, for example, in a case of using a postprocessing solution that enhances fastness, color development becomes deeper as the time from the landing of the ink to the landing of the postprocessing solution becomes longer. In a case of printing using these solutions, the color development becomes deeper as the time from the landing of the preprocessing solution to the landing of the postprocessing solution becomes longer. Accordingly, a density variation of the color development can be reduced by reducing a variation in the time from the landing of the preprocessing solution to the landing of the postprocessing solution.

Even when the time from the landing of the preprocessing solution to the landing of the postprocessing solution is the same, in a case where there is a difference between a percentage of the time from the landing of the preprocessing solution to the landing of the ink and a percentage of the time from the landing of the preprocessing solution to the landing of the postprocessing solution, a density of color development is not always the same. However, a range of the density of the color development can be narrowed by narrowing a range of time from the landing of the preprocessing solution to the landing of the postprocessing solution.

In order to solve the above problems, the disclosers of the present disclosure have newly found that by appropriately setting the arrangement of the preprocessing head 5 and the postprocessing head 6 on the carriage 3, it is possible to reduce a variation in the time from landing of the preprocessing solution to landing of the postprocessing solution even with respect to different image positions in the main scanning direction S. Specifically, the disclosers of the present disclosure have newly found that it is possible to reduce a variation in the time from the landing of the preprocessing solution to the landing of the postprocessing solution by appropriately setting the arrangement of the preprocessing head 5 and the postprocessing head 6 according to a relationship between the moving direction of the carriage 3 when the preprocessing head 5 ejects the preprocessing solution and the moving direction of the carriage 3 when the postprocessing head 6 ejects the postprocessing solution, in other words, according to the number of the ink head lines constituting the ink head 4 and a conveyance pitch of the workpiece W. A concept of the head arrangement and an arrangement example (Example) thereof on the basis of such new focusing point will be described below.

<Concept 1 of Head Arrangement>

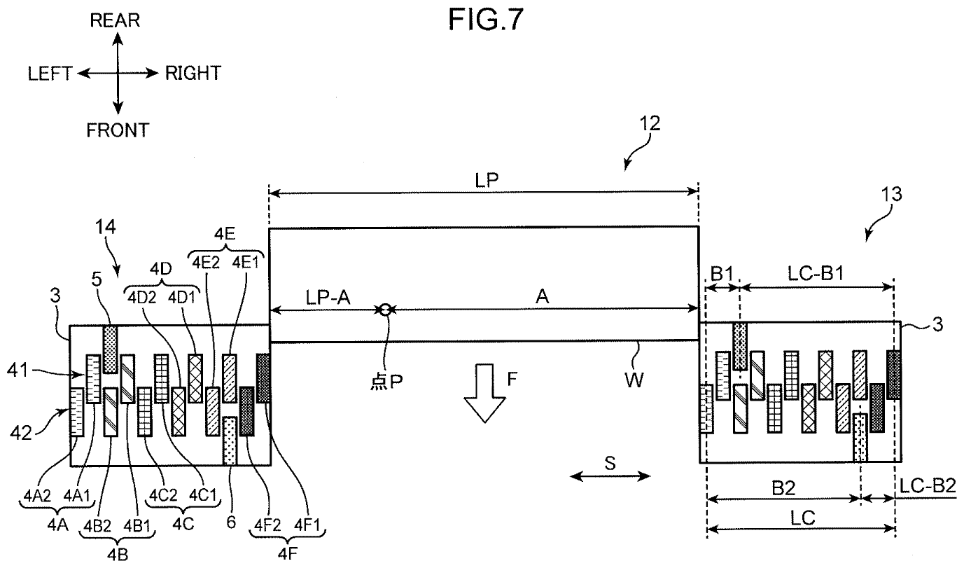

FIG. 7 is a schematic view for explaining landing time of the preprocessing solution, the ink, and the postprocessing solution at a point P on the workpiece W. In FIG. 7, the printing area 12 is arranged in the central portion, and the maintenance area 13 and the turnaround area 14 are arranged on both the left and right sides thereof. As described above, when the carriage 3 moves along the main scanning direction S between the maintenance area 13 and the turnaround area 14, the ink, the preprocessing solution, and the postprocessing solution are ejected from the ink head 4, the preprocessing head 5, and the postprocessing head 6 to the workpiece W, respectively. In FIG. 7, the carriage 3 is illustrated in both the maintenance area 13 and the turnaround area 14 for the sake of explanation. In the following, description will be made of a case where the ink head 4 has a plurality of even-numbered ink head lines, and printing is performed while the workpiece W is intermittently fed at one head pitch (the interval pitch between adjacent heads in the conveyance direction F), in particular, when the moving direction of the carriage 3 when the preprocessing head 5 ejects the preprocessing solution onto the workpiece W is different from the moving direction of the carriage 3 when the postprocessing head 6 ejects the postprocessing solution.

In FIG. 7, among the plurality of ink heads included in the plurality of ink head lines 41 and 42, the preprocessing head 5, and the postprocessing head 6, a head arranged closest to one end in the main scanning direction S is defined as a one-end side head, a head arranged closest to another end is defined as an other-end side head, a distance from the one-end side head to the other-end side head in the main scanning direction S is defined as LC, a distance from the one-end side head to the preprocessing head 5 in the main scanning direction S is defined as B1, and a distance from the one-end side head to the postprocessing head 6 in the main scanning direction S is defined as B2. In the example shown in FIG. 7, the one-end side head is the downstream side head 4A2 of the first ink head 4A, and the other-end side head is the upstream side head 4F1 of the sixth ink head 4F. Although the distances LC, B1, and B2 may be set on the basis of a part of the respective heads, the following description will be made of a mode where each distance described above is set on the basis of the center of each head in the main scanning direction S. The one-end side head and the other-end side head may be reversed. Note that basically, the center of the head in the main scanning direction S is a position of a virtual line in the main scanning direction S, the virtual line bisecting an area of a planar shape of the head viewed from above and being orthogonal to the main scanning direction S. In some cases, a position of a virtual line in the main scanning direction S may be considered as the center of the head in the main scanning direction S, the virtual line being orthogonal to the main scanning direction S and bisecting an area of a convex polygon having the smallest area among convex polygons including all the ejection nozzles of the head when viewed from above the head.

First, timing at which each solution lands on the point P on the workpiece W in the printing area 12 will be described. Since a moving speed of the carriage 3 is constant, description will be made in the following using a distance. Actual timing (time) can be calculated by dividing each distance by the moving speed of the carriage 3. Note that the point P is assumed to be at a position at a distance A from an end portion of the printing area 12 on the maintenance area 13 side.

Furthermore, it is assumed here that liquid from each head is ejected from the center in the main scanning direction S. In a case where the nozzles included in each head are actually distributed while spreading in the main scanning direction S, the spreading also affects the landing timing. However, since a difference between positions in the main scanning direction S of the nozzles in one head is smaller than a difference between positions in the main scanning direction S of the nozzles in different heads, the influence of head arrangement can be estimated in consideration of the foregoing.

Furthermore, in order to make the description easy to understand, the description is made as if the landing timing and the ejection timing are the same. In practice, the ejection is performed earlier than the landing timing by a flight time during which a liquid from the head to the workpiece W such that the liquid lands at a predetermined position at predetermined timing.

It is assumed that a one-way moving distance of the carriage 3 (a distance to move from the maintenance area 13 to the turnaround area 14) is a minimum distance LP+LC necessary for printing, and the carriage 3 is arranged in the maintenance area 13 as an initial position. In this case, in first movement operation (movement in the left direction) in which the carriage 3 moves from the maintenance area 13 to the turnaround area 14, timing T1 at which the preprocessing solution ejected from the preprocessing head 5 lands at the point P can be expressed by the following Formula A in terms of distance.

T1=A+B1 (Formula A)

In second movement operation (movement in the right direction) in which the carriage 3 moves from the turnaround area 14 to the maintenance area 13 after the preprocessing solution lands at the point P, the ink is ejected from each ink head of the first ink head line 41 to the point P. Furthermore, in third movement operation (movement in the left direction) in which the carriage 3 further moves from the maintenance area 13 to the turnaround area 14, the ink is ejected from each ink head of the second ink head line 42 to the point P.

Furthermore, in fourth movement operation (movement in the right direction) in which the carriage 3 moves from the turnaround area 14 to the maintenance area 13, timing T2 at which the postprocessing solution ejected from the postprocessing head 6 lands at the point P can be expressed by the following Formula B. Formula B includes times of the first to third movement operations.

T2=LP−A+LC−B2+3×(LP+LC) (Formula B)

As a result, time ΔT from the landing of the preprocessing solution at the point P to the landing of the postprocessing solution can be expressed by the following Formula C.

ΔT=T2−T1=LP−2 A+LC−(B1+B2)+3×(LP+LC) (Formula C)

Here, for the consideration of all the points on the workpiece W in the printing area 12, since the distance A can be assumed to change from 0 to LP, the range of ΔT in the above Formula C can be expressed by the following Formulas D, E, and F.

ΔTmin1≤ΔT≤ΔTmax1 (Formula D)

ΔTmin1=−LP+LC−(B1+B2)+3×(LP+LC) (Formula E)

ΔTmax1=LP+LC−(B1+B2)+3×(LP+LC) (Formula F)

On the other hand, during the printing on the workpiece W, the carriage 3 may first move from the turnaround area 14, i.e., may move in the right direction as the first movement operation. In this case, similarly to the above, the time ΔT from the landing of the preprocessing solution at the point P to the landing of the postprocessing solution can be expressed by the following Formula G.

ΔT=2A−LP−(LC−(B1+B2))+3×(LP+LC) (Formula G)

Also in this case, for the consideration of all the points on the workpiece W in the printing area 12, since the distance A can be assumed to change from 0 to LP, the range of ΔT in the above Formula G can be expressed by the following Formulas H, I, and J.

ΔTmin2≤ΔT≤ΔTmax2 (Formula H)

ΔTmin2=−LP−(LC−(B1+B2))+3×(LP+LC) (Formula I)

ΔTmax2=LP−(LC−(B1+B2))+3×(LP+LC) (Formula J)

From the foregoing, considering both the case where the carriage 3 moves from the maintenance area 13 and the case where the same moves from the turnaround area 14, from the above Formulas D to F and H to J, the time ΔT from the landing of the preprocessing solution at the point P to the landing of the postprocessing solution at the point P is distributed in a range of the following Formula K.

−LP−|(LC−(B1+B2))|+3×(LP+LC)≤ΔT≤LP+|(LC−(B1+B2))|+3×(LP+LC) (Formula K)

The consideration of the above Formula K finds that in order to narrow a distribution range of the time ΔT from landing of the preprocessing solution to landing of the postprocessing solution over the entire region of the workpiece W in the main scanning direction S, the preprocessing head and the postprocessing head 6 need be arranged on the carriage 3 such that an absolute value of LC−(B1+B2) becomes small. In other words, the most desirable form is a state in which the relationship of LC=B1+B2 is satisfied. Then, as a result of intensive experiments and consideration, the disclosers of the present disclosure have found that when Formula 1 below is satisfied, it is possible to form a stable image while reducing a variation in time from the landing of the preprocessing solution to the landing of the postprocessing solution on the workpiece W.

½≤(B1+B2)/LC≤3/2 (Formula 1)

Formula 1 represents that B1+B2 is within a range of 0.5 times or more and 1.5 times or less of LC. Considering only this landing timing, it is most desirable that B1+B2 coincides with LC as described above.

On the basis of the above idea, in the head arrangement shown in Example 1 of FIG. 6, the distance LC in the main scanning direction S from the downstream side head 4A2 of the first ink head 4A to the upstream side head 4F1 of the sixth ink head 4F is set to LC=11, the distance B1 in the main scanning direction S from the downstream side head 4A2 to the preprocessing head 5 is set to B1=6, the distance B2 in the main scanning direction S from the downstream side head 4A2 to each of the postprocessing heads 6 is set to B2=5 or 7, and (B1+B2)/LC is 1 or 1.18, and it can be seen that the above Formula 1 is satisfied in either distance B2. Accordingly, the variation in the time from the landing of the preprocessing solution to the landing of the postprocessing solution can be reduced regardless of the moving direction of the carriage 3. As a result, the preprocessing solution, the ink, and the postprocessing solution can be stably and sequentially landed on the workpiece W, making image quality hardly vary on the workpiece W.

In a case where at least one of the preprocessing head 5 and the postprocessing head 6 is arranged in plural as illustrated in FIG. 6, it is desirable that at least one head of the plurality of heads is arranged so as to satisfy Formula 1. By thus arranging at least one processing head so as to satisfy Formula 1, it is possible to further eject a processing solution from other processing head in addition to reducing the variation in the time from the landing of the preprocessing solution to the landing of the postprocessing solution, so that it is possible to increase an ejectable amount of the processing solution.

Furthermore, it is further desirable that all of the plurality of heads described above are arranged so as to satisfy Formula 1. In this case, while the variation in the time from the landing of the preprocessing solution to the landing of the postprocessing solution can be further reduced, an ejectable amount of the processing solution can be increased.

### Example 2

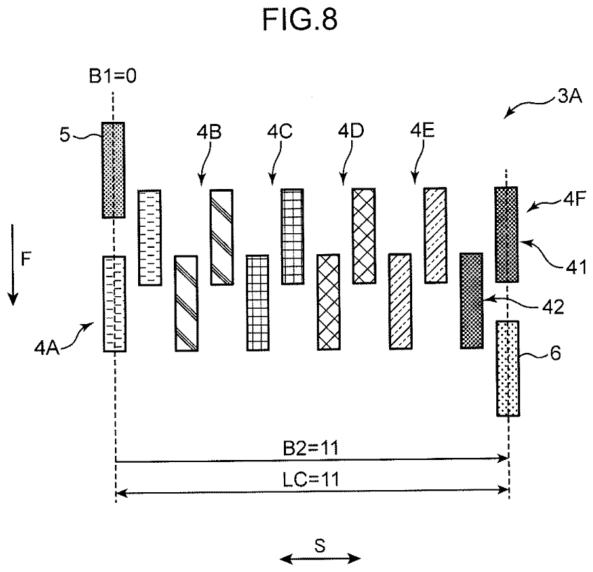

Furthermore, FIG. 8 is a plan view of a carriage 3A showing head arrangement according to Example 2. In Example 2, the preprocessing head 5 is located at the left end of an array of all the heads, and the postprocessing head 6 is located at the right end of the array. In the head arrangement, LC=11, B1=0, and B2=11, and (B1+B2)/LC is 1, which indicates that the above Formula 1 is satisfied.

### Example 3

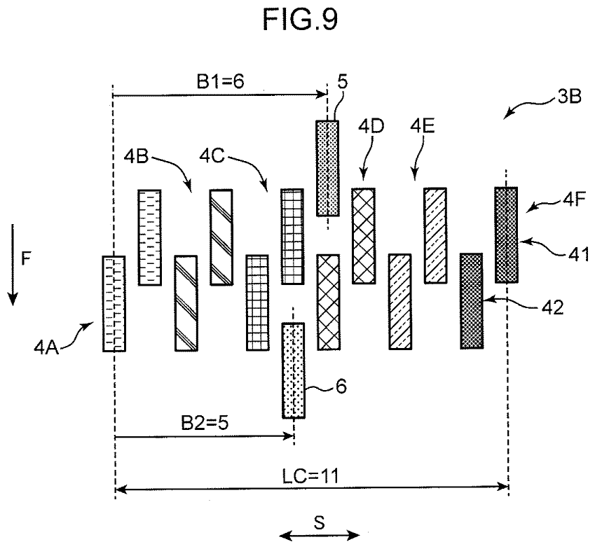

Furthermore, FIG. 9 is a plan view of a carriage 3B showing head arrangement according to Example 3. In Example 3, the preprocessing head 5 and the postprocessing head 6 are located at a substantially central portion in the main scanning direction S of the array of all the heads. In the head arrangement, LC=11, B1=6, and B2=5, and (B1+B2)/LC is 1, which indicates that the above Formula 1 is satisfied.

### Example 4

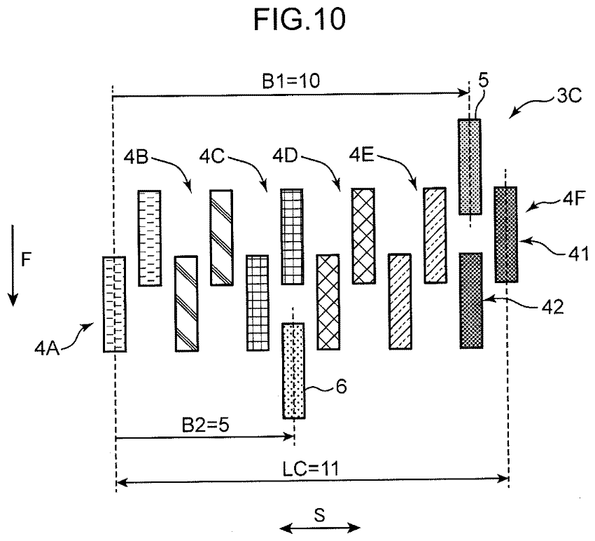

Furthermore, FIG. 10 is a plan view of a carriage 3C showing head arrangement according to Example 4. In Example 4, the preprocessing head 5 is located in the vicinity of the right end of the array of all the heads, and the postprocessing head 6 is located at a substantially central portion in the main scanning direction S of the array. In the head arrangement, LC=11, B1=10, and B2=5, and (B1+B2)/LC is 1.36, which indicates that the above Formula 1 is satisfied.

### Example 5

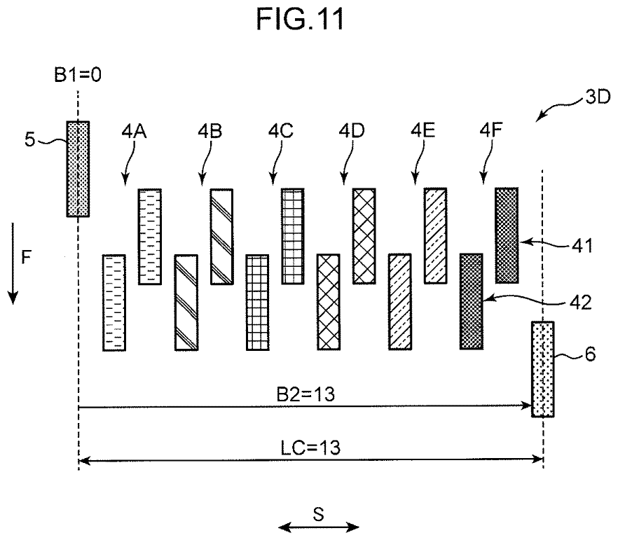

Furthermore, FIG. 11 is a plan view of a carriage 3D showing head arrangement according to Example 5. In the head arrangement, LC=13, B1=0, and B2=13, and (B1+B2)/LC is 1, which indicates that the above Formula 1 is satisfied. As shown in FIG. 11, the preprocessing head 5 may be arranged closer to one end in the main scanning direction S than the ink head 4, and the postprocessing head 6 may be arranged closer to the other end in the main scanning direction S than the ink head 4.

### Example 6

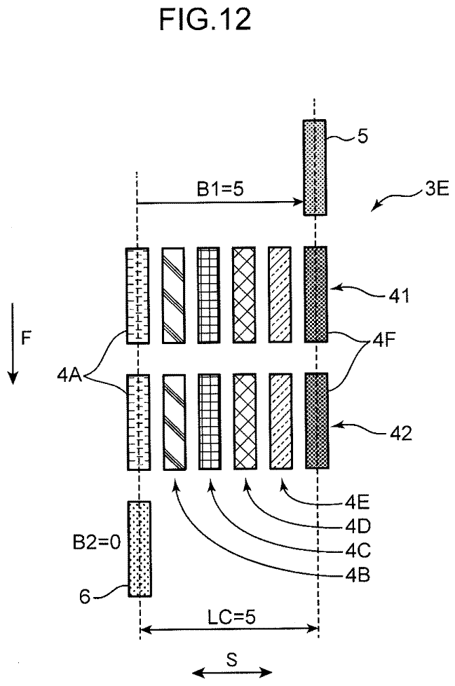

Furthermore, FIG. 12 is a plan view of a carriage 3E showing head arrangement according to Example 6. In the head arrangement, LC=5, B1=5, and B2=0, and (B1+B2)/LC is 1, which indicates that the above Formula 1 is satisfied. As shown in FIG. 12, the first ink head line 41 and the second ink head line 42 are not limited to staggered arrangement, and may be arranged side by side at intervals in the conveyance direction F. The preprocessing head 5 and the postprocessing head 6 are not limited to the staggered arrangement either, and may be arranged at intervals on the upstream side and the downstream side in the conveyance direction F of the ink head 4.

<Concept 2 of Head Arrangement>

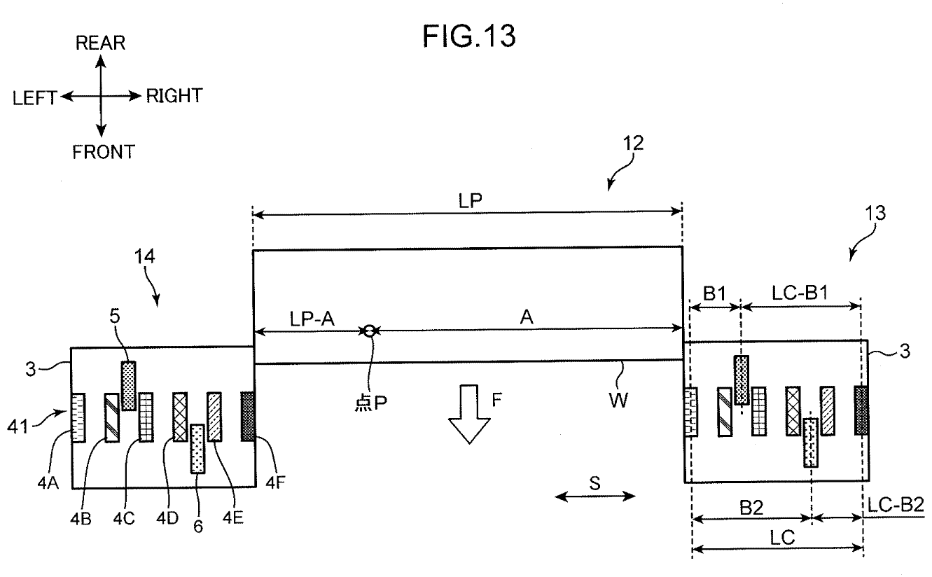

FIG. 13 is a schematic view for explaining landing time of the preprocessing solution, the ink, and the postprocessing solution at the point P on the workpiece W similarly to FIG. 7. In the following, description will be made of a case where when the ink heads 4 has odd-numbered ink head lines, the moving direction of the carriage 3 when the preprocessing head 5 ejects the preprocessing solution onto the workpiece W is the same as the moving direction of the carriage 3 when the postprocessing head 6 ejects the postprocessing solution. Description of parts common to the contents of the description based on FIG. 7 will be omitted. In FIG. 13, the ink head 4 has one ink head line (the first ink head line 41). In the example shown in FIG. 13, the one-end side head is the first ink head 4A, and the other-end side head is the sixth ink head 4F.

As shown in FIG. 13, in a case where the ink head 4 has odd-numbered ink head lines, and printing is performed while the workpiece W is intermittently fed at one head pitch (the interval pitch between adjacent heads in the conveyance direction F), the moving direction (the main scanning direction) of the carriage 3 when the preprocessing head 5 ejects the preprocessing solution is the same as the moving direction of the carriage 3 when the postprocessing head 6 ejects the postprocessing solution. Therefore, the time Δ from the landing of the preprocessing solution to the landing of the postprocessing solution does not depend on the position of the point P in the main scanning direction S.

Specifically, in first movement operation (movement in the left direction) in which the carriage 3 moves from the maintenance area 13 to the turnaround area 14, the timing T1 at which the preprocessing solution ejected from the preprocessing head 5 lands at the point P can be expressed by the following Formula L.

T1=A+B1 (Formula L)

In second movement operation (movement in the right direction) in which the carriage 3 moves from the turnaround area 14 to the maintenance area 13 after the preprocessing solution lands at the point P, the ink is ejected from each ink head of the first ink head line 41 to the point P.

Furthermore, in the third movement operation (movement in the left direction) in which the carriage 3 moves from the maintenance area 13 to the turnaround area 14, the timing T2 at which the postprocessing solution ejected from the postprocessing head 6 lands at the point P can be expressed by the following Formula M.

T2=A+B2+2×(LP+LC) (Formula M)

As a result, the time ΔT from the landing of the preprocessing solution at the point P to the landing of the postprocessing solution can be expressed by the following Formula N.

ΔT=T2−T1=B2−B1+2×(LP+LC) (Formula N)

When similarly considering a case where the carriage 3 moves from the turnaround area 14 to the maintenance area 13 (movement in the left direction) in the first operation, the time ΔT from the landing of the preprocessing solution at the point P to the landing of the postprocessing solution can be expressed by the following Formula O.

$$Δ T = LC - B 2 - ( LC - B 1 ) + 2 \times ( LP + LC ) = B 1 - B 2 + 2 \times ( LP + LC ) \qquad ( Formula O )$$

Since the printing is intermittently performed in the conveyance direction F of the workpiece W, the workpiece W will have a part where portions printed at different timings are adjacent in the conveyance direction F. Referring to FIGS. 5A and 5B, the regions A1 and A2 are printed at different timings. Furthermore, since the main scanning direction S of printing of each head in the region A1 is reversed to that in the region A2, a time interval of landing of each solution of the preprocessing solution, the ink, and the postprocessing solution lands is also different, so that a printing result might differ due to a difference in printing conditions. Note that such a boundary where the main scanning direction S of the printing changes is referred to as a scanning boundary. A large difference between the times ΔT in the above Formulas N and O at a scanning boundary might make the scanning boundary be conspicuous due to a difference in a printing result. For example, a difference in color development density might be conspicuous which is caused by the influence of a difference in time between the landing of the preprocessing solution and the landing of the postprocessing solution. Therefore, an absolute value of a time difference Δt (Formula P), which is a difference between ΔT of Formula N and ΔT of Formula O, is desirably small.

Δt=2×(B1−B2) (Formula P)

The disclosers of the present disclosure have used an absolute value of (B1−B2)/LC as an index, which is obtained by dividing the above-described Δt by a distance LC×2 in order to standardize Δt, and have found that the absolute value is desirably ½ or less, and in particular, most desirably B1=B2, as shown in Formula 2 below.

|(B1−B2)/LC|≤½ (Formula 2)

By arranging the preprocessing head 5 and the postprocessing head 6 so as to satisfy the above Formula 2, the difference in time from the landing of the preprocessing solution to the landing of the postprocessing solution at the scanning boundary can be reduced. This means that a variation in time from the landing of the preprocessing solution to the landing of the postprocessing solution can be reduced. As a result, the preprocessing solution, the ink, and the postprocessing solution can be stably and sequentially landed on the workpiece W, making image quality hardly vary on the workpiece W.

As in the case of Formula 1, when at least one of the preprocessing head 5 and the postprocessing head 6 is arranged in plural, it is desirable that at least one head of the plurality of heads is arranged so as to satisfy Formula 2, and it is more desirable that all of the plurality of heads are arranged so as to satisfy Formula 2. Also in this case, it is possible to further eject a processing solution from other processing head in addition to reducing the variation in the time from the landing of the preprocessing solution to the landing of the postprocessing solution at a scanning boundary, so that an ejectable amount of the processing solution can be increased.

Furthermore, not only the head arrangement defined by the above Formula 2 but also the head arrangement defined by the above Formula 1 can be said to be appropriate from the viewpoint of the above evaluation at the scanning boundary.

### Example 7

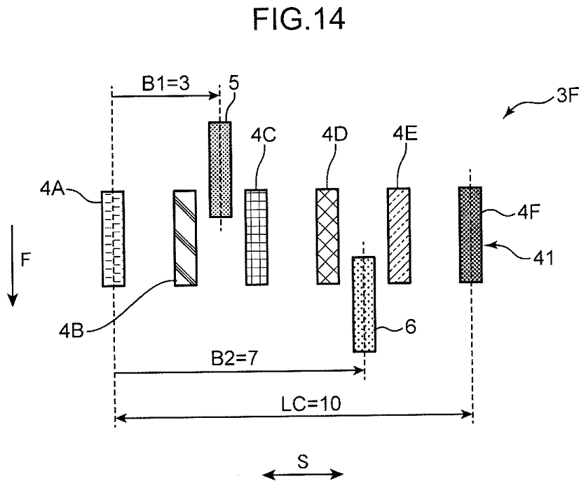

FIG. 14 is a plan view of a carriage 3F showing head arrangement according to Example 7. On the basis of the above concept, in the head arrangement, LC=10, B1=3, and B2=7, and |(B1−B2)/LC| is 0.4, which indicates that the above Formula 2 is satisfied. Note that in the present Example, an interval (distance) between the adjacent heads of the ink head 4 in the main scanning direction S is 2. A distance between the preprocessing head 5 and the second ink head 4B or the third ink head 4C in the main scanning direction S is 1, and a distance between the postprocessing head 6 and the fourth ink head 4D or the fifth ink head 4E in the main scanning direction S is also 1.

### Example 8

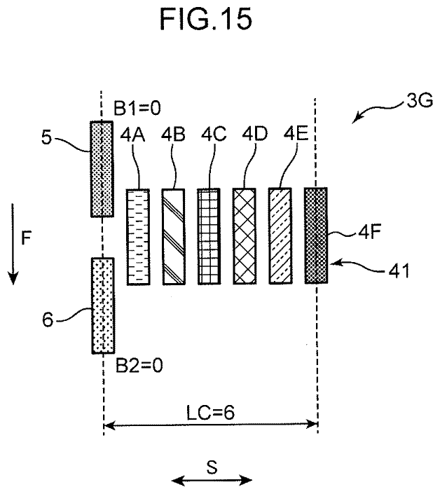

FIG. 15 is a plan view of a carriage 3G showing head arrangement according to Example 8. In the present Example, the preprocessing head 5 and the postprocessing head 6 correspond to one-end side heads. In this head arrangement, LC=6, B1=0, and B2=0, and |(B1−B2)/LC| is 0, which indicates that the above Formula 2 is satisfied.

Desirable head arrangement will be further described below on the basis of other Examples.

### Example 9

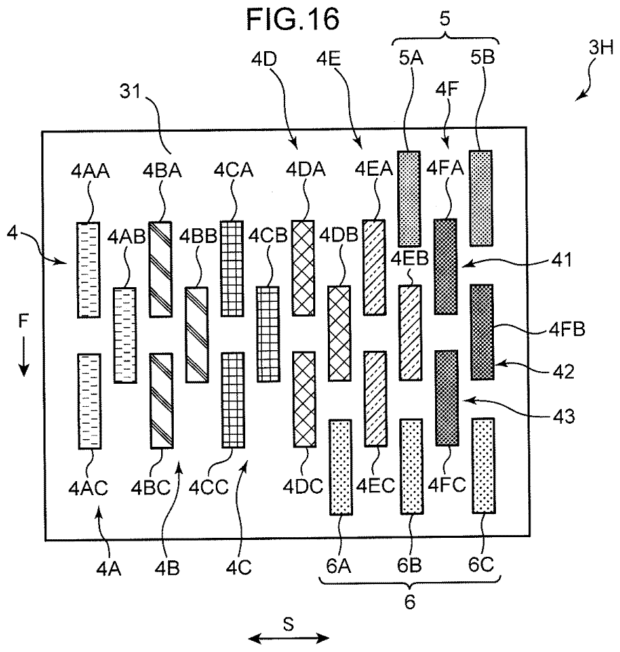

FIG. 16 is a plan view schematically showing a carriage 3H having head arrangement according to Example 9. Example 9 is different from Example 1 in that the number of unit heads in each head is increased. Specifically, although the ink head 4 is the same as that of Example 1 in including the first to sixth ink heads 4A to 4F that respectively eject the inks of the six colors different from each other, each of the ink heads 4A to 4F of the respective colors includes three unit heads (total 18). In other words, the ink head 4 has three ink head lines (odd-numbered lines) including the first ink head line 41, the second ink head line 42, and a third ink head line 43. The preprocessing head 5 arranged on the upstream side in the conveyance direction F of the ink head 4 includes two unit heads, and the postprocessing head 6 arranged on the downstream side includes three unit heads. Note that the preprocessing head 5 and the postprocessing head 6 are arranged within the range of the arrangement width of the ink head 4 in the main scanning direction S, which is the same as Example 1.

The first ink head 4A includes an upstream side head 4AA, a central head 4AB, and a downstream side head 4AC as the unit heads. Of the first ink head 4A, the upstream side head 4AA is arranged on a most upstream side in the conveyance direction F of the carriage 3A. The downstream side head 4AC is arranged downstream of the upstream side head 4AA at the same position as the upstream side head 4AA in the main scanning direction S. The central head 4AB is arranged at a position shifted rightward in the main scanning direction S from the upstream side head 4AA and the downstream side head 4AC, and is arranged downstream of the upstream side head 4AA and upstream of the downstream side head 4AC in the conveyance direction F. The central head 4AB is arranged at a position partially overlapping the upstream side head 4AA and the downstream side head 4AC in the conveyance direction F.

The second to sixth ink heads 4B to 4F also include upstream side heads 4BA, 4CA, 4DA, 4EA, and 4FA, central heads 4BB, 4CB, 4DB, 4EB, and 4FB, and downstream side heads 4BC, 4CC, 4DC, 4EC, and 4FC, respectively, which are similar to the upstream side head 4AA, the central head 4AB, and the downstream side head 4AC described above. The upstream side heads 4AA to 4FA, the central heads 4BB to 4FB, and the downstream side heads 4BC to 4FC of the first to sixth ink heads 4A to 4F, respectively, are aligned at the same position in the conveyance direction F and at predetermined intervals in the main scanning direction S to configure the first ink head line 41, the second ink head line 42, and the third ink head line 43.

The preprocessing head 5 includes a first preprocessing head 5A and a second preprocessing head 5B arranged at the same position in the conveyance direction F and spaced apart side by side in the main scanning direction S. The first preprocessing head 5A is arranged so as to have a part of its downstream portion interposed between the upstream side head 4EA of the fifth ink head 4E and the upstream side head 4FA of the sixth ink head 4F. The second preprocessing head 5B is arranged on the right side of the upstream side head 4FA and at the same position as the central head 4FB in the main scanning direction S.

The postprocessing head 6 includes the first postprocessing head 6A, the second postprocessing head 6B, and the third postprocessing head 6C arranged at the same position in the conveyance direction F and spaced apart side by side in the main scanning direction S. The first postprocessing head 6A is arranged so as to have a part of its upstream portion interposed between the downstream side head 4DC of the fourth ink head 4D and the downstream side head 4EC of the fifth ink head 4E. The second postprocessing head 6B is arranged so as to have a part of its upstream portion interposed between the downstream side head 4EC of the fifth ink head 4E and the downstream side head 4FC of the sixth ink head 4F. The third postprocessing head 6C is arranged on the right side of the downstream side head 4FC and at the same position as the central head 4FB in the main scanning direction S.

In Example 9, the odd-numbered ink head lines are provided, and the above-described LC=11, B1=9, 11, and B2=7, 9, 11. When |(B1−B2)/LC| in Formula 2 is calculated on the basis of these combinations, |(B1-B2)/LC| is distributed at 0 and 0.18, and 0.36, and it is found that the relationship of Formula 2 is satisfied.

Additionally, according to the head arrangement according to Example 9, the same advantages as those of Example 1 can be obtained. In other words, it is possible to increase ejection amounts of necessary ink and processing solution while reducing the size of the carriage 3H. In particular, in Example 9, since both the preprocessing head 5 and the postprocessing head 6 include a plurality of unit heads, it is possible to sufficiently increase the ejection amounts of the preprocessing solution and the postprocessing solution. Since the first to sixth ink heads 4A to 4F also include the unit heads arranged in three lines, a sufficiently large ejection amount of ink can be obtained.

### Example 10

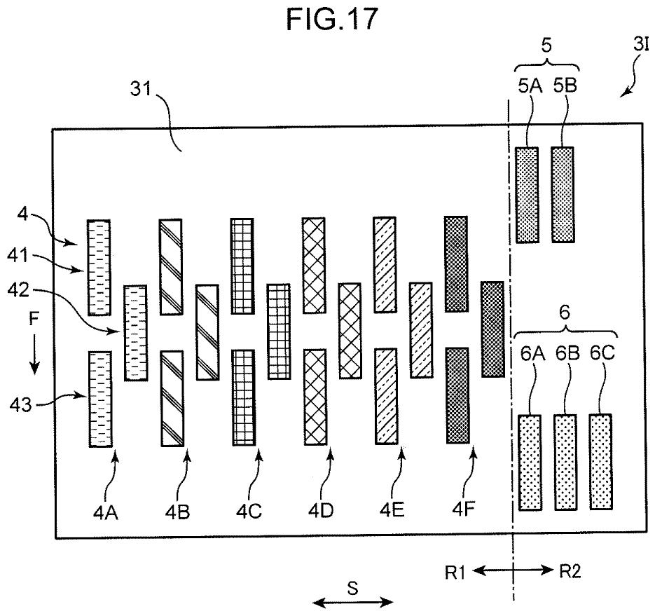

FIG. 17 is a plan view schematically showing a carriage 31 having head arrangement according to Example 10. Example 10 shows an example in which the ink head 4 that ejects ink, and the preprocessing head 5 and the postprocessing head 6 that eject a non-coloring processing solution are separately arranged in the main scanning direction.

On the head support frame 31 of the carriage 31, the first to sixth ink heads 4A to 4F that respectively eject the inks of the six different colors, the preprocessing head 5 and the postprocessing head 6 are mounted. The first to sixth ink heads 4A to 4F each include the unit heads arranged in three lines similarly to Example 9. The preprocessing head 5 includes the first and second preprocessing heads 5A and 5B arranged at the same position in the conveyance direction F and spaced apart side by side in the main scanning direction S. The postprocessing head 6 includes the first to third postprocessing heads 6A to 6C arranged at the same position in the conveyance direction F and spaced apart side by side in the main scanning direction S. These basic configurations are the same as those of Example 9.

In Example 10, an arrangement region of the ink head 4 and an arrangement region of the preprocessing head 5 and the postprocessing head 6 are divided on the head support frame 31. On the head support frame 31, there are set a first region R1 having a relatively large area and a second region R2 having a relatively small area adjacent to the first region R1 in the main scanning direction S. The ink head 4 (the first to sixth ink heads 4A to 4F) is arranged in the first region R1. On the other hand, the preprocessing head 5 and the postprocessing head 6 are not arranged in the first region R1, but are arranged in the second region R2. In the second region R2, the preprocessing head 5 is arranged upstream of the array of the ink heads 4 in the conveyance direction F, and the postprocessing head 6 is arranged downstream of the same.

In the head arrangement in Example 10 having such odd-numbered ink head lines, LC=14, B1=12, 13, and B2=12, 13, 14. When |(B1−B2)/LC| in Formula 2 is calculated on the basis of these combinations, |(B1−B2)/LC| is distributed at 0 and 0.07, and 0.14, and it is found that the relationship of Formula 2 is satisfied.

Note that when the ink comes into contact with the preprocessing solution or the postprocessing solution, ink components might aggregate. In this case, when aggregate adheres to the ink ejection nozzle of the ink head 4, an ejection failure might occur. Furthermore, there is also a concern that in a system for collecting a waste liquid generated in the cleaning processing, the purge processing, or the like of the head, the ink comes into contact with the processing solution to aggregate and clogs a collection path. According to the carriage 31 of Example 10, since the processing heads 5 and 6 and the ink head 4 are separately arranged in the main scanning direction S, it is possible to make the contact between the ink and the preprocessing solution or the postprocessing solution hardly occur. Accordingly, it is possible to make the problem caused by the aggregation of the ink hardly occur.

### Example 11

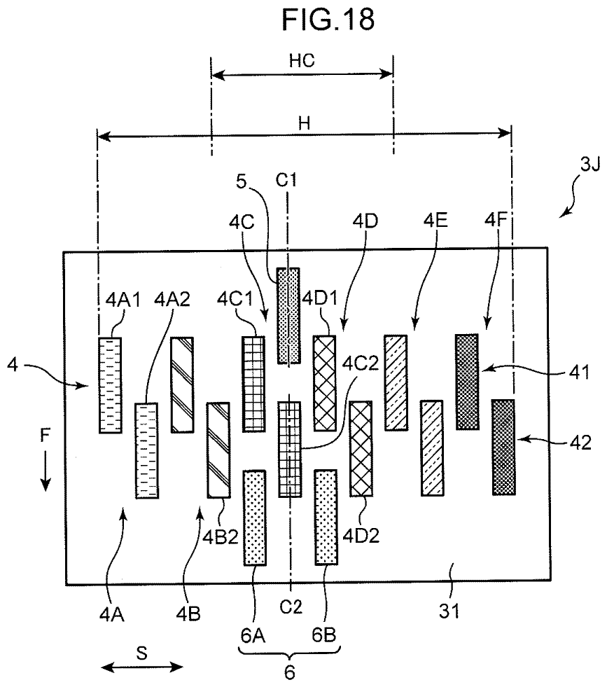

FIG. 18 is a plan view schematically showing a carriage 3J having head arrangement according to Example 11. Examples 8 to 10 show the examples where the preprocessing head 5 and the postprocessing head 6 are arranged near the end portion (near the right end) of the arrangement width H of the ink head 4 in the main scanning direction S. Similarly to Example 1 (FIG. 6), Example 11 shows an example in which the preprocessing head 5 and the postprocessing head 6 are arranged in a central region HC of the arrangement width H. Example 11 is, however, different from Example 1 in the arrangement of the ink heads 4 as will be described later.

On the head support frame 31 of the carriage 3J, the first to sixth ink heads 4A to 4F that respectively eject the inks of the six different colors, the preprocessing head 5 and the postprocessing head 6 are mounted. The first to sixth ink heads 4A to 4F each include the unit heads arranged in two lines similarly to Example 1. Note that a shift direction of the downstream side head of each of the ink heads 4A to 4F is reverse to that of Example 1, such as the downstream side head 4A2 is arranged on the right side of the upstream side head 4A1 in the first ink head 4A. One preprocessing head 5 and two postprocessing heads 6, the first and second postprocessing heads 6A and 6B, are provided.

The preprocessing head 5 and the postprocessing head 6 are arranged in the central region HC in the arrangement width H of the first to sixth ink heads 4A to 4F in the main scanning direction S. The present example is the same as the above Example 1 in that the preprocessing head 5 is arranged upstream of the array of the first to sixth ink heads 4A to 4F in the conveyance direction F, and the postprocessing head 6 is arranged downstream of the same. The preprocessing head 5 is arranged at the same position as the downstream side head 4C2 of the third ink head 4C in the main scanning direction S and on the upstream side of the downstream side head in the conveyance direction F. The preprocessing head 5 is arranged so as to have a part of its downstream portion interposed between the upstream side heads 4C1 and 4D1 of the third and fourth ink heads 4C and 4D.

The first and second postprocessing heads 6A and 6B are arranged at the same position in the conveyance direction F and arranged side by side at predetermined intervals in the main scanning direction S. The first postprocessing head 6A is arranged so as to have its upstream side portion interposed between the downstream side head 4B2 of the second ink head 4B and the downstream side head 4C2 of the third ink head 4C. The second postprocessing head 6B is arranged so as to have its upstream side portion interposed between the downstream side head 4C2 and the downstream side head 4D2 of the fourth ink head 4D.

In the head arrangement in Example 11 having such even-numbered ink head lines, LC=11, B1=5, and B2=4, 6. When (B1+B2)/LC in Formula 1 is calculated on the basis of these combinations, (B1+B2)/LC is distributed at 0.8 and 1, and it is found that the relationship of Formula 1 is satisfied.

In addition, the preprocessing head 5 and the postprocessing head 6 are not only arranged in the central region HC of the arrangement width H, but also arranged such that an arrangement center of the preprocessing head 5 and an array center of the first and second postprocessing heads 6A and 6B coincide with each other in the main scanning direction S. In the present Example, since there is only one preprocessing head 5, the center of the preprocessing head 5 in the main scanning direction S will be an arrangement center C1. The postprocessing head 6 has an intermediate point between the first postprocessing head 6A and the second postprocessing head 6B as an array center C2. The preprocessing head 5 and the postprocessing head 6 are arranged on the head support frame 31 such that the arrangement center C1 and the array center C2 are at the same position in the main scanning direction S.

As described with reference to FIG. 4, in the present embodiment, the carriage 3 repeats the forward main scanning and the backward main scanning to sequentially land the preprocessing solution, the ink, and the postprocessing solution on the workpiece W. By adopting the head arrangement of Example 11 when such two-way main scanning is adopted, it is possible to reduce, at each main scanning position, particularly a variation in time from landing of the preprocessing solution to landing of the ink on the workpiece W and a variation in time from landing of the ink to landing of the postprocessing solution.

In this case, the central region HC is desirably a region located at the center of the range of the arrangement width H and having a width of half the arrangement width H, and further desirably ⅓ of the same. That the processing head is arranged in the central region HC means that the array center of the processing heads is arranged in the central region HC, and half or more of the arrangement centers of the processing heads are arranged in the central region HC. Furthermore, all the arrangement centers of the processing heads may be arranged in the central region HC.

### Example 12

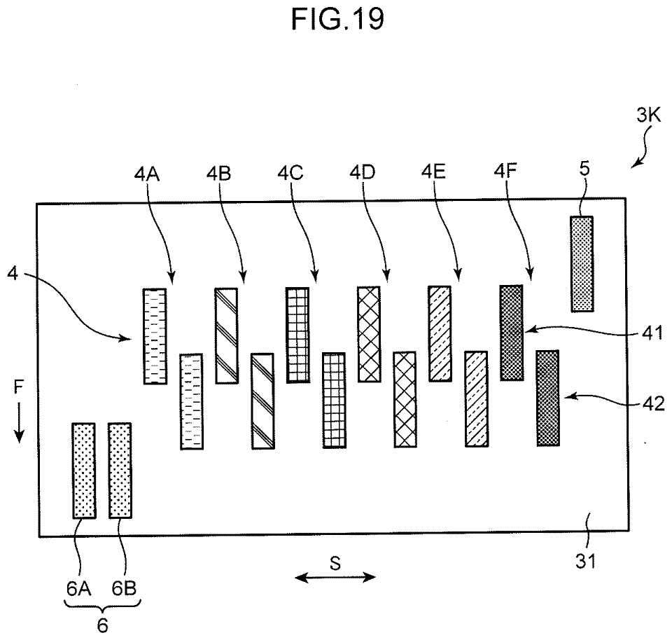

FIG. 19 is a plan view schematically showing a carriage 3K having head arrangement according to Example 12. Example 12 shows an example in which the preprocessing head 5 and the postprocessing head 6 are separately arranged on one end side and the other end side in the main scanning direction S of the head support frame 31 with the ink head 4 interposed therebetween. On the head support frame 31, the first to sixth ink heads 4A to 4F having the same manner of an array as in Example 11 (FIG. 18), the preprocessing head 5, and the postprocessing head 6 are mounted. One preprocessing head 5 and two postprocessing heads 6, the first and second postprocessing heads 6A and 6B, are provided. The preprocessing head 5 is arranged on the other end side (right side) of the ink head 4 in the main scanning direction S and on the upstream side in the conveyance direction F. The first and second postprocessing heads 6A and 6B are arranged on the one end side (left side) of the ink head 4 in the main scanning direction S and on the downstream side in the conveyance direction F. The first and second postprocessing heads 6A and 6B are arranged at the same position in the conveyance direction F and spaced apart side by side in the main scanning direction S.

In the head arrangement in Example 12 having such even-numbered ink head lines, LC=14, B1=14, and B2=0, 1. When (B1+B2)/LC in Formula 1 is calculated on the basis of these combinations, (B1+B2)/LC is distributed at 1 and 1.07, and it is found that the relationship of Formula 1 is satisfied.

In addition, similarly to Example 10, the head arrangement of Example 12 is also an example in which the arrangement region of the ink head 4 and the arrangement region of the preprocessing head 5 and the postprocessing head 6 are divided on the head support frame 31. Specifically, a right end portion of the head support frame 31 is the arrangement region of the preprocessing head 5, a left end portion of the same is the arrangement region of the postprocessing head 6, and a remaining central region is the arrangement region of the ink head 4. The head arrangement of Example 12 also enables contact of the ink with the preprocessing solution or the postprocessing solution to hardly occur.

### Example 13

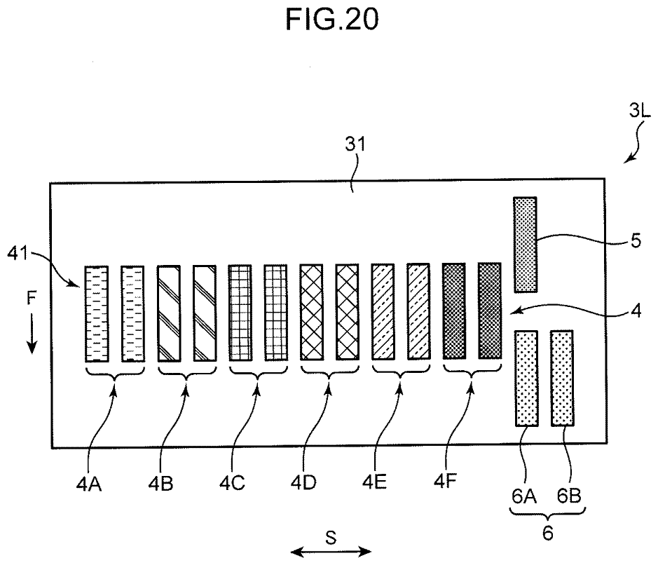

FIG. 20 is a plan view schematically showing a carriage 3L having head arrangement according to Example 13. Example 13 illustrates the ink head 4 (the first ink head line 41) in which the first to sixth ink heads 4A to 4F that respectively eject the inks of the six different colors are aligned in the main scanning direction S.

On the head support frame 31 of the carriage 3L, the first to sixth ink heads 4A to 4F each including two unit heads, the preprocessing head 5, and the postprocessing head 6 are mounted. One preprocessing head 5 and two postprocessing heads 6, the first and second postprocessing heads 6A and 6B, are provided. The difference from Examples 1 and the like described above is that the first to sixth ink heads 4A to 4F each including two unit heads are arrayed in the main scanning direction S at the same position in the conveyance direction F. The preprocessing head 5 and the postprocessing head 6 are arranged on the upstream side and the lower side, respectively, on the right of the array of the first to sixth ink heads 4A to 4F.

In the head arrangement in Example 13 having such one ink head line, LC=13, B1=12, and B2=12, 13. When |(B1−B2)/LC| in Formula 2 is calculated on the basis of these combinations, |(B1−B2)/LC| is distributed at 0 and 0.08, and it is found that the relationship of Formula 2 is satisfied.

Additionally, since in the head arrangement of Example 13, the width in the main scanning direction S can be made relatively large, it is suitable when a width in the conveyance direction F should be shortened. In addition, it is possible to increase ejection amounts of necessary ink and processing solution. Furthermore, since the arrangement region of the ink head 4 and the arrangement region of the preprocessing head 5 and the postprocessing head 6 are divided on the head support frame 31, it is possible to make contact of the ink with the preprocessing solution or the postprocessing solution hardly occur.

### Example 14

Example 14, and Example 15 to follow illustrate head arrangement in which a measure against heat generation of the processing heads 5 and 6 is taken. Generally, a head that ejects liquid by a jet method generates heat for pressurizing the liquid using electricity. The ink head 4 performs the ejection operation only at the time of forming a necessary color dot. By contrast, the preprocessing head 5 and the postprocessing head 6 require the ejection operation of the preprocessing solution and the postprocessing solution corresponding to dots of all colors. Accordingly, the preprocessing head 5 and the postprocessing head 6 are liable to have higher temperatures than the ink heads 4. Therefore, it is desirable to conduct head arrangement assuming that the preprocessing head 5 and the postprocessing head 6 will have high temperatures.

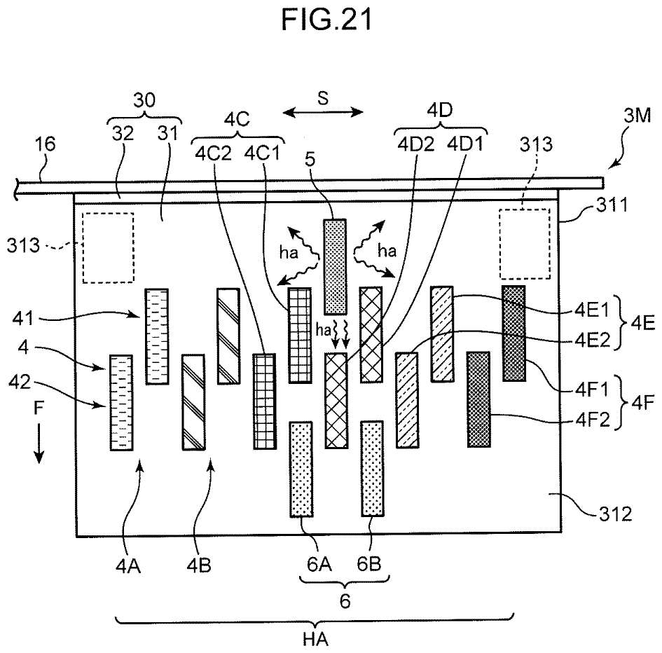

FIG. 21 is a plan view schematically showing a carriage 3M having head arrangement according to Example 14. In the carriage 3M, the back frame 32 (engagement portion) is held by the guide rails 17 (holding members) (FIG. 1) in the cantilevered state. On the head support frame 31, the ink head 4 including the first to sixth ink heads 4A to 4F, one preprocessing head 5, and the postprocessing head 6 including the first and second postprocessing heads 6A and 6B are mounted. Since the arrangement of the heads is the same as that of Example 1 shown in FIG. 6, description thereof is omitted here.

In such head arrangement in Example 14, LC=11, B1=6, and B2=5, 7. When (B1+B2)/LC in Formula 1 is calculated on the basis of these combinations, (B1+B2)/LC is distributed at 1 and 1.18, and it is found that the relationship of Formula 1 is satisfied.

In addition, in the present Example, the preprocessing head 5 is configured with one unit head, and the postprocessing head 6 is configured with two unit heads (the first and second postprocessing heads 6A and 6B). Among the preprocessing head 5 and the postprocessing head 6, the preprocessing head 5 having a smaller number of the unit head is arranged on the proximal end side 311 of the head support frame 31. The postprocessing head 6 having a large number of the unit heads is arranged on the distal end side 312. In other words, an upstream side end edge of the head support frame 31 in the conveyance direction F is the side held by the guide rails 17.

As described in the foregoing, the processing heads 5 and 6 generate heat by the ejection operation. As schematically illustrated in FIG. 21, the preprocessing head 5 heated to a high temperature dissipates heat ha. The same applies to the first and second postprocessing heads 6A and 6B. The head support frame 31 of the carriage 3M is heated by the heat ha, so that thermal deformation might be caused on the head support frame 31, the back frame 32 which is a holding structure of the head support frame, a fixing metal for fixing the back frame 32 and the timing belt 16, and the like. This thermal deformation could affect landing accuracy of the ink ejected from the ink head 4 in the carriage 3M held in the cantilevered state.

However, in the carriage 3M of Example 14, the preprocessing head 5 having the smaller number of the unit head is arranged on the proximal end side 311, which is the side on which the head support frame 31 is cantilevered. As a result, it is possible to reduce the influence (decrease in landing accuracy) of thermal deformation. If the postprocessing head 6 having the large number of the unit heads is arranged on the proximal end side 311, the back frame 32 receives heat ha dissipated from the two unit heads, and is more likely to have a high temperature and to be thermally deformed.

Furthermore, in the carriage 3M of Example 14, the preprocessing head 5 is arranged at a position excluding the end in the main scanning direction S of a head array HA (head arrangement region) of the ink head 4 and the processing heads 5 and 6. Among the heads 4, 5, and 6 mounted on the carriage 3M, the preprocessing head 5 is a head arranged on a side closest to the back frame 32 (engagement portion). Such preprocessing head 5 is arranged at a position excluding an arrangement end 313 which is an end of the head array HA.

Since the carriage 3M cannot be increased in size uselessly, if the head is arranged at the arrangement end 313 of the head array in the main scanning direction S, the head will be a head closest to a corner of the carriage 3M (the head support frame 31) in the main scanning direction S. Since the vicinity of the arrangement end 313 is also the vicinity of the cantilevered back frame 32, thermal deformation occurring in that vicinity can invite distortion or positional deviation in a height direction or a horizontal direction of the head support frame 31. This lowers accuracy of a landing position of the heads 4, 5, and 6 mounted on the carriage 3M. Therefore, by not arranging, in a region of the arrangement end 313, the preprocessing head 5 and the postprocessing head 6 that will have a high temperature, it is possible to make the above-described problem of thermal deformation hardly occur.

The present Example has staggered arrangement in which among the two lines of the ink heads 4 (the first ink head line 41 and the second ink head line 42), the line of the heads 4 arranged on the engagement portion side is at a position shifted to the right side in FIG. 21. Furthermore, the preprocessing head 5, which is a processing head with the smaller number of the head, is arranged on the engagement portion side, and the preprocessing head 5 is arranged at the center of the arrangement positions forming the staggered arrangement. With such arrangement, the heads can be arranged such that no processing head is arranged at the arrangement end 313.

A preferable arrangement example of the ink heads will be further described with reference to the head arrangement of the carriage 3M illustrated in FIG. 21. In the carriage 3M, the preprocessing head 5 that will have a high temperature is arranged so as to have a part thereof adjacent to the ink head 4. Specifically, the preprocessing head 5 is adjacent to the upstream side heads 4C1 and 4D1 of the third and fourth ink heads 4C and 4D, respectively, in the main scanning direction S, and is adjacent to the downstream side head 4D2 of the fourth ink head 4D in the conveyance direction F. In addition, the first postprocessing head 6A is adjacent to the downstream side heads 4C2 and 4D2 of the third and fourth ink heads 4C and 4D, respectively, in the main scanning direction S, and is adjacent to the upstream side head 4C1 in the conveyance direction F. The second postprocessing head 6B is adjacent to the downstream side heads 4D2 and 4E2 of the fourth and fifth ink heads 4D and 4E, respectively, in the main scanning direction S, and is adjacent to the upstream side head 4D1 in the conveyance direction F. On the other hand, the preprocessing head 5 and the postprocessing head 6 are not adjacent to the first, second, and sixth ink heads 4A, 4B, and 4F.

In the above head arrangement, for example, the third, fourth, and fifth ink heads 4C, 4D and 4E (the first ink heads that eject the first color ink) that eject yellow, red, and blue inks, respectively, have a larger number of the unit heads (total number of the heads) adjacent to the preprocessing head 5 and the postprocessing head 6 than the first, second, and sixth ink heads 4A, 4B, and 4F (the second ink heads that eject the second color ink) that eject orange, green, and black inks, respectively. In other words, the third, fourth, and fifth ink heads 4C, 4D, and 4E are ink heads that are likely to have a higher temperature than the other ink heads 4A, 4B, and 4F.

When viscosity of the ink greatly changes with a temperature change, characteristics of ink ejection (ejection amount and the like) from the ink head also change. Viscosity change characteristics due to temperature vary with a type of ink. Accordingly, in the case of the present Example, as the ink to be ejected from the third, fourth, and fifth ink heads 4C, 4D, and 4E that are likely to have a high temperature, ink is selected that has a smaller viscosity change caused by temperature than the ink to be ejected from the first, second, and sixth ink heads 4A, 4B, and 4F. As a result, even if the third, fourth, and fifth ink heads 4C, 4D, and 4E are heated by the preprocessing head 5 and the postprocessing head 6, a change of the ejection amount and the ejection speed of the ink ejected from each of these ink heads 4C, 4D, and 4E with the temperature can be reduced.

In this case, for each ink, the number of the unit heads of the processing head adjacent to the ink head 4 may be evaluated as the largest number of the unit heads of the processing heads adjacent to the ink head 4 that ejects a certain ink. With respect to the first, second, and sixth ink heads 4A, 4B, and 4F, the maximum number of the unit heads of the adjacent processing heads is zero. With respect to the third ink head 4C, the maximum number of the unit heads of the adjacent processing heads is two, and with respect to the fourth ink head 4D, the maximum number of the unit heads of the adjacent processing heads is three. With respect to the fifth ink head 4E, the maximum number of the unit heads of the adjacent processing heads is one.

Furthermore, for each ink, the number of the unit heads of the processing head adjacent to the ink head 4 may be evaluated as an average of the numbers of the unit heads of the processing heads adjacent to the ink head 4 that ejects a certain ink. With respect to the first, second, and sixth ink heads 4A, 4B, and 4F, an average number of unit heads of adjacent processing heads is zero. With respect to the third ink head 4C, the average number of the unit heads of the adjacent processing head is 1.5, and with respect to the fourth ink head 4D, the average number of the unit heads of the adjacent processing head is 2.5. With respect to the fifth ink head 4E, the average number of the unit heads of the adjacent processing head is 0.5.

As evaluation obtained by combining these manners, for example, the maximum number of the unit heads of the adjacent processing head may be evaluated first, and with respect to ink having no difference in this evaluation, an average of the numbers of the unit heads of the adjacent processing heads may be evaluated.

Furthermore, an order of likelihood of having a high temperature among the ink heads 4 that eject the respective inks may be evaluated, and ink having less change in viscosity with temperature may be ejected in the order of likelihood of having a high temperature.

### Example 15

Example 15 illustrates Example in consideration of measures against rise of the temperature of the preprocessing head 5 and the postprocessing head 6 among a plurality of same color ink heads that eject inks of the same color. The above Examples show the examples in which each of the first to sixth ink heads 4A to 4F of the respective colors includes two or three unit heads. When a difference in the number of adjacent preprocessing heads 5 or the postprocessing heads 6 is large among the unit heads, there occurs a problem that the ink ejection characteristics greatly differ among the unit heads. The present Example shows a head arrangement example in which the difference in the number of adjacent heads is reduced.

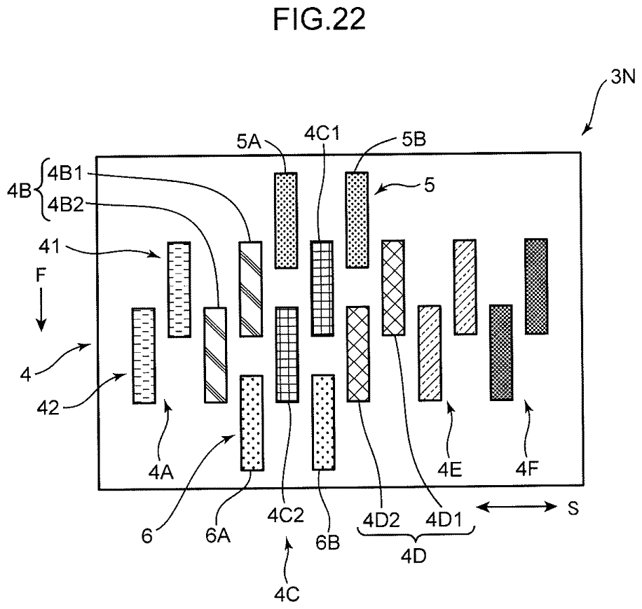

FIG. 22 is a plan view schematically showing a carriage 3N having head arrangement according to Example 15. The carriage 3N has head arrangement in which a difference between a maximum value and a minimum value of a count number is one or less, the count number being the number of the preprocessing heads 5 or the postprocessing heads 6 adjacent to each of the two unit heads (same color ink heads) of the first to sixth ink heads 4A to 4F in the main scanning direction S and the conveyance direction F.

In the head arrangement of the carriage 3N, arrangement of the ink head 4 is the same as the head arrangement of the carriage 3M illustrated in FIG. 21. By contrast, the preprocessing head 5 includes the first and second preprocessing heads 5A and 5B arranged side by side in the main scanning direction S with the upstream side head 4C1 of the third ink head 4C interposed therebetween. The postprocessing head 6 includes the first and second postprocessing heads 6A and 6B arranged side by side in the main scanning direction S with the downstream side head 4C2 interposed therebetween.

For the second ink head 4B of the carriage 3N, the count numbers of the processing heads 5 and 6 adjacent to the upstream side head 4B1 and the downstream side head 4B2 in the main scanning direction S and the conveyance direction F are two and one, respectively, and the difference is “one”. For the third ink head 4C, the count number for each of the upstream side head 4C1 and the downstream side head 4C2 is three, and the difference is “zero”. For the fourth ink head 4D, the count number for the upstream side head 4D1 is one, the count number for the downstream side head 4D2 is two, and the difference is one. The remaining ink heads 4A, 4E, and 4F all have the count number of “zero”. Accordingly, the difference between the maximum value and the minimum value for all of the first to sixth ink heads 4A to 4F is one or less, which satisfies the above requirement.

As described in the foregoing, in Example 15, a difference between the maximum value and the minimum value of the count number is set to be one or less, the count number being the number of the processing heads 5 and 6 adjacent to each of the upstream side heads 4A1 to 4F1 and the downstream side heads 4A2 to 4F2 of the first to sixth ink heads 4A to 4F, respectively. This prevents the plurality of same color ink heads from having a large difference in the ink ejection amount.

### Example 16

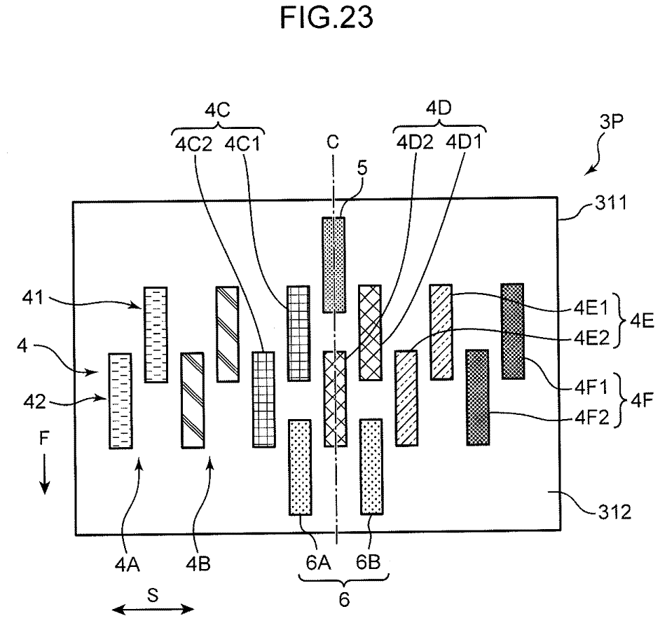

FIG. 23 is a plan view schematically showing a carriage 3P having head arrangement according to Example 16. Example 16 shows an example in which contact of the preprocessing solution and the postprocessing solution with the ink can be reduced by arranging the preprocessing head 5 and the postprocessing head 6 in a cluster as much as possible on the head support frame 31 instead of dispersedly arranging the same.

Example 16 illustrates head arrangement satisfying the following requirements (A) to (C).
(A) Of the preprocessing head 5 and the postprocessing head 6, when a larger number of the unit heads is denoted as m and a smaller number of the unit heads is denoted as n, a requirement, m=n+odd number, is satisfied,
(B) the arrangement or array center of one or a plurality of the preprocessing heads 5 and the arrangement or array center of one or a plurality of the postprocessing heads 6 in the main scanning direction S coincide with each other in the main scanning direction S, and
(C) the arrangement or array center of the preprocessing head 5 and the postprocessing head 6 coincides with the arrangement position of one ink head of the ink head 4 in the main scanning direction S.

The carriage 3P illustrated in FIG. 23 includes the ink head 4, one preprocessing head 5, and the postprocessing head 6 having the first and second postprocessing heads 6A and 6B. The head arrangement is the same as in FIG. 21 and the like. Therefore, the head arrangement in Example 16 also satisfies the relationship of Formula 1 described above. In this example, m=2 corresponds to the postprocessing head 6 and n=1 corresponds to the preprocessing head 5. Therefore, the above requirement (A), m=n+odd number, is satisfied. The arrangement center of the preprocessing head 5 and the array center of the postprocessing head 6 are both at a center C in the drawing, which also satisfies the requirement (B). Furthermore, the center C and the arrangement position of the downstream side head 4D2 of the fourth ink head 4D coincide with each other, which also satisfies the requirement (C).

According to the head arrangement of Example 16, the preprocessing head 5 and the postprocessing head 6 can be mounted on the carriage 3P in a cluster to some extent. Thus, among the first to sixth ink heads 4A to 4F, the number of ink heads arranged at positions close to the preprocessing head 5 or the postprocessing head 6 can be reduced. Therefore, it is possible to reduce the possibility of contact of the preprocessing solution and the postprocessing solution with the ink on the carriage.

### Example 17

Example 17 illustrates a preferable arrangement relationship between the heads 4, 5, and 6 on the carriage and sub-tanks that supply the ink or the processing solution to these heads. FIG. 24 is a plan view showing a carriage 3Q having head arrangement and sub-tank arrangement according to Example 17. The carriage 3Q includes the ink head 4 having the first to sixth ink heads 4A to 4F, one preprocessing head 5, and the postprocessing head 6 having the first and second postprocessing heads 6A and 6B. The head arrangement is the same as in FIG. 21 and the like. Therefore, the head arrangement in Example 17 also satisfies the relationship of Formula 1 described above.

The sub-tank 7 is also mounted on the carriage 3Q. The sub-tank 7 includes ink sub-tanks 7A to 7F, a preprocessing solution sub-tank 71, and a postprocessing solution sub-tank 72 (both are sub-tanks for processing solution). Ink, a preprocessing solution, and a postprocessing solution are supplied to these sub-tanks 7 from a main tank (not illustrated). The ink sub-tanks 7A to 7F supply the ink to the first to sixth ink heads 4A to 4F, respectively. For example, the first color ink is supplied from a first tank 7A1 of the ink sub-tank 7A to the upstream side head 4A1 of the first ink head 4A and from a second tank 7A2 to the downstream side head 4A2 via the pipeline P1. Similarly, the second to sixth ink heads 4B to 4F are structured to be supplied with the inks of the second to sixth colors.

An arrangement order of the ink sub-tanks 7 in the main scanning direction S is the same as the arrangement order of the ink heads 4 in the main scanning direction S, the ink heads 4 receiving supply of the inks from the ink sub-tanks 7. The ink may be supplied from one ink sub-tank 7 to the plurality of ink heads 4 that eject the inks of the same color. In this case, the ink heads 4 sharing the ink sub-tank 7 may be positioned in a cluster in the main scanning direction S. Furthermore, the ink heads 4 that eject the same ink may be arranged in a cluster in the main scanning direction S, and an order of arrangement of the ink sub-tanks 7 of the respective colors may be the same as an order of arrangement of the ink heads 4 of the respective colors in the main scanning direction S.

The preprocessing solution sub-tank 71 supplies the preprocessing solution to the preprocessing head 5 via the pipeline P2. The postprocessing solution sub-tank 72 includes a first tank 72A and a second tank 72B. The first and second tanks 72A and 72B respectively supply the postprocessing solution to the first and second postprocessing heads 6A and 6B via the pipeline P3.

The ink sub-tanks 7A to 7F are mounted on the carriage 3Q so as to be aligned in the main scanning direction S. The processing solution sub-tanks 71 and 72 are arranged side by side in the main scanning direction S at positions different from the ink sub-tanks 7A to 7F in the conveyance direction F. Specifically, the preprocessing solution sub-tank 71 and the first and second tanks 72A and 72B of the postprocessing solution sub-tank 72 are aligned in the main scanning direction S on the downstream side in the conveyance direction F of the ink sub-tanks 7A to 7F. Only the preprocessing solution sub-tank 71 may be arranged upstream of the ink sub-tanks 7A to 7F.

On a liquid in the sub-tank 7 mounted on the carriage 3Q that reciprocates in the main scanning direction S, acceleration in the main scanning direction S acts. While the sub-tank 7 and the heads 4, 5, and 6 are connected by the pipelines P1, P2, and P3, when the sub-tanks 7 are widely distributed on the carriage 3Q, an arrangement range of the pipelines P1 to P3 in the main scanning direction S is also increased. Since also the pipelines P1 to P3 are filled with the ink or the processing solution, meniscus breakdown might occur at ejection portions of the heads 4, 5, and 6 due to the influence of the acceleration.

According to the configuration of Example 17, the ink sub-tanks 7A to 7F are mounted on the carriage 3Q so as to be aligned in the main scanning direction S similarly to the first to sixth ink heads 4A to 4F. Therefore, the ink sub-tanks 7A to 7F can be arranged in a relatively narrow range on the head support frame 31 of the carriage 3Q. Similarly, the preprocessing solution sub-tank 71 and the postprocessing solution sub-tank 72 can also be arranged in a relatively narrow range on the head support frame 31 of the carriage 3Q.

Furthermore, since the preprocessing solution sub-tank 71 and the postprocessing solution sub-tank 72 are arranged at positions different from the ink sub-tanks 7A to 7F in the conveyance direction F, it is possible to arrange the preprocessing solution sub-tank 71 and the postprocessing solution sub-tank 72 so as to have a small difference in position in the main scanning direction S from the processing heads to which the preprocessing solution sub-tank 71 and the postprocessing solution sub-tank 72 supply the processing solution. As a result, it is possible to reduce a distribution range in the main scanning direction S of the preprocessing solution being continuously present in the preprocessing solution sub-tank 71, the pipeline P, and the preprocessing head 5, thereby making the preprocessing solution be less affected by the acceleration. Similarly, it is possible to reduce a distribution range in the main scanning direction S of the postprocessing solution being continuously present, thereby making the postprocessing solution be less affected by the acceleration.

Similarly, the ink sub-tanks 7A to 7F and the ink heads 4 to which the ink sub-tanks 7A to 7F respectively supply ink can be arranged with a small difference in position in the main scanning direction S. This makes it possible to reduce a distribution range in the main scanning direction S of the ink continuously present, thereby making the ink be less affected by the acceleration.

<Conveyance Pitch of Workpiece W>

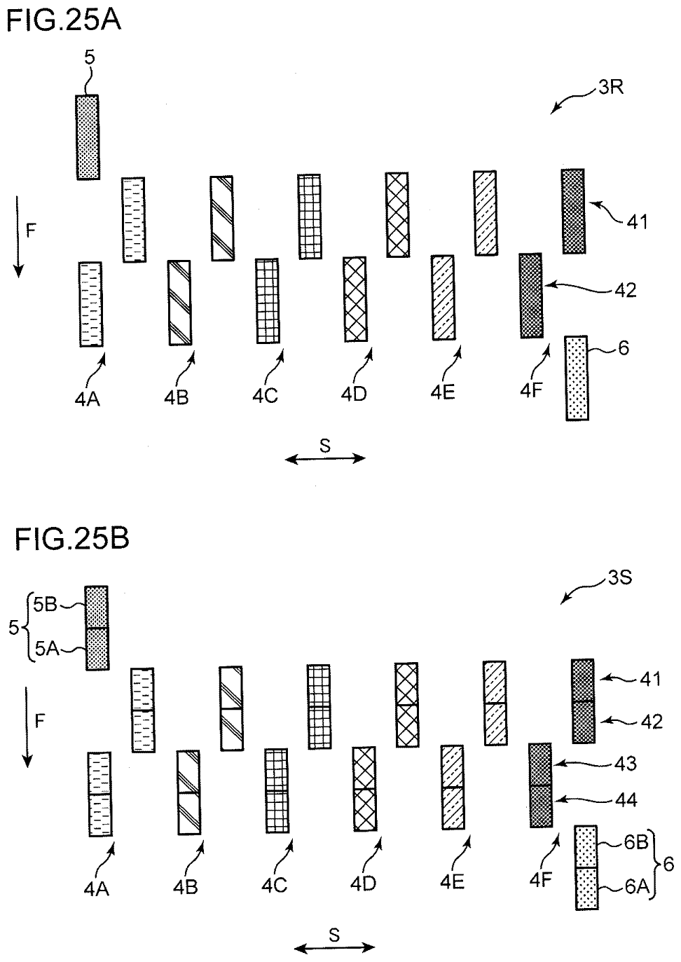

Although in each of the above Examples, the description has been made of the case where printing is performed while the workpiece W is intermittently fed at one head pitch (the interval pitch between adjacent heads in the conveyance direction F), the present disclosure is not limited thereto, and FIGS. 25A and 25B are schematic views for explaining a case where the workpiece W is conveyed at different conveyance pitches. In the following description, it is assumed that in a case of printing on the workpiece W at a maximum density, each processing solution and ink are printed on the workpiece W in every main scanning.

With reference to FIG. 25A, in a case where an even-numbered ink head lines (the first ink head line 41, second ink head line 42) are provided, when the conveyance pitch of the workpiece W is set to a ½ head pitch (a pitch of ½ of the interval between the adjacent heads in the conveyance direction F), such condition can be considered the same as the case of one head pitch in such head arrangement as illustrated in FIG. 25B. Specifically, in FIG. 25B, the ink head 4 includes the first ink head line 41, the second ink head line 42, the third ink head line 43, and a fourth ink head line 44, the preprocessing head 5 includes the first preprocessing head 5A and the second preprocessing head 5B, and the postprocessing head 6 includes the first postprocessing head 6A and the second postprocessing head 6B. The intervals of the respective heads in the conveyance direction F are the same.

As shown in FIG. 25B, when at least one (both in FIG. 25B) of the preprocessing head 5 and the postprocessing head 6 has a plurality of processing heads in the conveyance direction F, the evaluations of Formulas 1 and 2 may be performed by focusing on a time interval from the last landing preprocessing solution among the preprocessing solutions to the first landing postprocessing solution among the postprocessing solutions. In FIG. 25B, since the values of B1 and B2 at which the effect is exhibited are the same as those in the case where four lines of the ink heads are arranged, the above-described Formula 1 need only be satisfied. Thus, even in a case of carrying out printing at 1/n head pitch (a pitch of 1/n of the interval between the adjacent heads in the conveyance direction F, n as a natural number) feed, it can be evaluated by Formula 1 or Formula 2 in the same manner.

Furthermore, considering a case where the ink head 4 has odd-numbered ink head lines and the workpiece W is fed at the conveyance pitch=1/n head pitch, since a case where the natural number n of the conveyance pitch is an odd number can be considered the same as a case where the number of the ink head lines is an odd number, Formula 2 can be applied. On the other hand, when the natural number n of the conveyance pitch is an even number, Formula 1 can be applied similarly to the case where the number of the ink head lines is an even number.

As described in the foregoing, even when the conveyance pitch of the workpiece W is a pitch other than one head pitch, a variation in time from the landing of the preprocessing solution to the landing of the postprocessing solution can be reduced by the arrangement of the preprocessing head 5 and the postprocessing head 6 satisfying Formulas 1 and 2 as described above.

From the foregoing, in the following cases I and II, a scanning direction of the carriage 3 when the preprocessing head 5 ejects the preprocessing solution (a direction of the last scanning when there are a plurality of scanning of the preprocessing head accompanying ejection) and a scanning direction of the carriage 3 when the postprocessing head 6 ejects the postprocessing solution (a direction of the first scanning when there are a plurality of scanning of the postprocessing head accompanying ejection) are opposite to each other.
I: A case where the ink head 4 has even-numbered ink head lines in the conveyance direction F (in this case, the feed pitch of the workpiece W may be one head pitch or 1/n head pitch)
II: A case where the ink heads 4 has odd-numbered ink head lines in the conveyance direction F, and the feed pitch of the workpiece W is 1/n head pitch (n is an even number)

In this case, the preprocessing head 5 and the postprocessing head 6 need only be arranged so as to satisfy Formula 1.

Additionally, in a case III below, a scanning direction of the carriage 3 when the preprocessing head 5 ejects the preprocessing solution (a direction of the last scanning when there are a plurality of scanning of the preprocessing head accompanying ejection) and a scanning direction of the carriage 3 when the postprocessing head 6 ejects the postprocessing solution (a direction of the first scanning when there are a plurality of scanning of the postprocessing head accompanying ejection) are the same.
III: A case where the ink head 4 has odd-numbered ink head lines in the conveyance direction F, and the feed pitch of the workpiece W is one head pitch or 1/n head pitch (n is an odd number)

In this case, the preprocessing head 5 and the postprocessing head 6 need only be arranged so as to satisfy Formula 2.

<Inkjet Recording Method>

As described above, the inkjet printer 1 described in each Example includes one ink head line mounted at a predetermined position in the conveyance direction F on the carriage 3 or the plurality of ink head lines mounted on the carriage 3 so as to be aligned in the conveyance direction F, the preprocessing head, and the postprocessing head. Each of the one or plurality of ink head lines includes a plurality of ink heads that are arranged side by side in the main scanning direction S and eject inks for image formation. The preprocessing head 5 is arranged on the upstream side with respect to the one or plurality of ink head lines in the conveyance direction F and ejects a non-coloring preprocessing solution. The postprocessing head 6 is arranged on the downstream side with respect to the one or plurality of ink head lines in the conveyance direction F and ejects a non-coloring postprocessing solution.

Then, one inkjet recording method in the inkjet printer 1 described above is a method including: arranging the preprocessing head 5 and the postprocessing head 6 so as to satisfy a relationship of ½≤(B1+B2)/LC≤3/2 . . . (Formula 1) in a case where among the plurality of ink heads 4, the preprocessing head 5, and the postprocessing head 6, a head arranged closest to one end in the main scanning direction S is defined as a one-end side head, a head arranged closest to another end is defined as an other-end side head, a distance from the one-end side head to the other-end side head in the main scanning direction S is defined as LC, a distance from the one-end side head to the preprocessing head 5 in the main scanning direction S is defined as B1, and a distance from the one-end side head to the postprocessing head 6 in the main scanning direction S is referred to B2; ejecting a preprocessing solution from the preprocessing head 5 to a predetermined recording region on the workpiece W while moving the carriage 3 in a first direction (e.g., the left direction) in the main scanning direction S; feeding the workpiece W at a predetermined feed pitch in the conveyance direction F, and ejecting ink from the ink head 4 to the recording region that has received the ejected preprocessing solution while moving the carriage 3 in the main scanning direction S; and further feeding the workpiece W at the feed pitch in the conveyance direction F, and ejecting a postprocessing solution from the postprocessing head 6 to the recording region that has received the ejected ink while moving the carriage 3 in a second direction (e.g., the right direction) opposite to the first direction in the main scanning direction S.

By such method, it is possible to efficiently form an image on a workpiece W by the all-in-one inkjet printer 1 in which three kinds of heads for ejecting the preprocessing solution, the ink, and the postprocessing solution are mounted on one carriage 3. Furthermore, since the preprocessing head 5, the ink head 4, and the postprocessing head 6 are sequentially arranged in the conveyance direction F, the preprocessing solution, the ink, and the postprocessing solution can be ejected in a desirable landing order. Furthermore, by appropriately arranging the preprocessing head 5 and the postprocessing head 6 so as to satisfy Formula 1, it is possible to reduce a variation in time from the landing of the preprocessing solution to the landing of the postprocessing solution. As a result, variations in image quality hardly occur on the workpiece W.

In particular, according to the above method, a variation in time from the landing of the preprocessing solution to the landing of the postprocessing solution can be reduced in a case where the ink head 4 has even-numbered ink head lines in the conveyance direction, or in a case where the ink head 4 has odd-numbered ink head lines in the conveyance direction F, and a feed pitch of the workpiece W is 1/n head pitch (n is an even number).

Furthermore, another inkjet recording method in the inkjet printer 1 described above is a method including: arranging the preprocessing head 5 and the postprocessing head 6 so as to satisfy a relationship of |(B1−B2)/LC|≤½ . . . (Formula 2); ejecting a preprocessing solution from the preprocessing head 5 to a predetermined recording region on the workpiece W while moving the carriage 3 in a first direction (e.g., the left direction) in the main scanning direction S; feeding the workpiece W at a predetermined feed pitch in the conveyance direction F, and ejecting ink from the ink head 4 to the recording region that has received the ejected preprocessing solution while moving the carriage 3 in the main scanning direction S; and further feeding the workpiece W at the feed pitch in the conveyance direction F, and ejecting a postprocessing solution from the postprocessing head 6 to the recording region that has received the ejected ink while moving the carriage 3 in the first direction in the main scanning direction S.

Also by such method, it is possible to efficiently form an image on a workpiece W by the all-in-one inkjet printer 1 in which three kinds of heads for ejecting the preprocessing solution, the ink, and the postprocessing solution are mounted on one carriage. Furthermore, since the preprocessing head 5, the ink head 4, and the postprocessing head 6 are sequentially arranged in the conveyance direction, the preprocessing solution, the ink, and the postprocessing solution can be ejected in a desirable landing order. Furthermore, by appropriately arranging the preprocessing head 5 and the postprocessing head 6 so as to satisfy Formula 2, it is possible to reduce a variation in time from the landing of the preprocessing solution to the landing of the postprocessing solution. As a result, variations in image quality hardly occur on the workpiece W.

In particular, according to the above method, a variation in time from the landing of the preprocessing solution to the landing of the postprocessing solution can be reduced in a case where the ink head 4 has odd-numbered ink head lines in the conveyance direction F, and the feed pitch of the workpiece W is one head pitch or 1/n head pitch (n is an odd number).

### Comparative Example

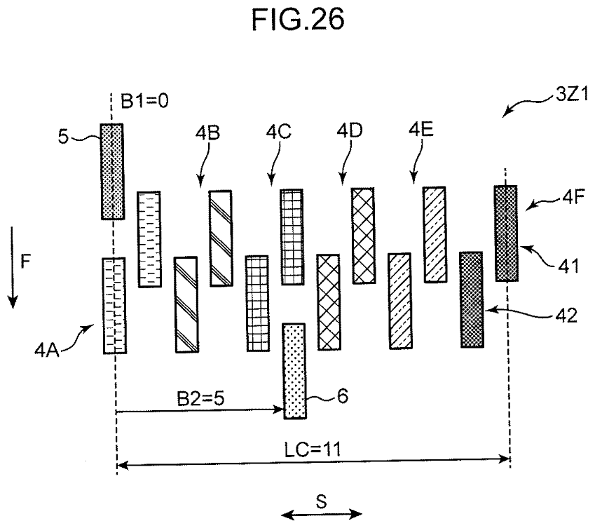

FIG. 26 is a plan view of a carriage 3Z1 showing head arrangement according to Comparative Example 1 to be compared with the present disclosure. In the head arrangement in Comparative Example 1 having such even-numbered ink head lines, LC=11, B1=0, and B2=5. When (B1+B2)/LC in Formula 1 is calculated on the basis of the combination, (B1+B2)/LC is distributed at 0.45, and it is found that the relationship of Formula 1 is not satisfied.

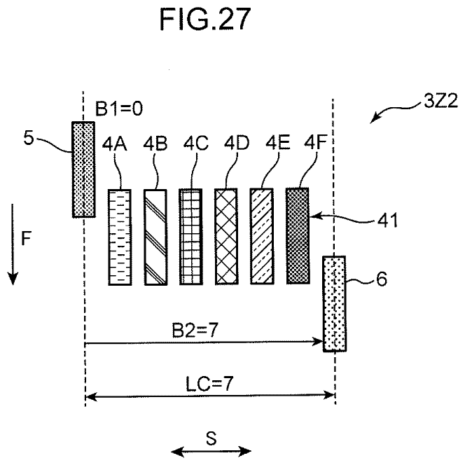

Similarly, FIG. 27 is a plan view of a carriage 3Z2 showing head arrangement according to Comparative Example 2 to be compared with the present disclosure. In the head arrangement in Comparative Example 2 having such odd-numbered ink head lines, LC=7, B1=0, and B2=7. When |(B1−B2)/LC| in Formula 2 is calculated on the basis of the combination, |(B1−B2)/LC| is distributed at 1, and it is found that the relationship of Formula 2 is not satisfied.

In the cases of the head arrangements as shown in FIGS. 26 and 27, the time from the landing of the preprocessing solution to the landing of the postprocessing solution varies depending on an image position in the main scanning direction, resulting in that image quality is likely to vary on the workpiece W.

### Conclusion of Present Disclosure

An inkjet recording device according to one aspect of the present disclosure includes a conveyance unit, a carriage, a plurality of ink head lines, a preprocessing head, and a postprocessing head. The conveyance unit is configured to convey a recording medium in a conveyance direction. The carriage is configured to reciprocate in a main scanning direction intersecting the conveyance direction. The plurality of ink head lines includes an even-numbered ink head lines. The plurality of ink head lines is located on the carriage and aligned in the conveyance direction. The preprocessing head is arranged on an upstream side of the plurality of ink head lines in the conveyance direction and configured to eject a non-coloring preprocessing solution. The postprocessing head is arranged on a downstream side of the plurality of ink head lines in the conveyance direction and configured to eject a non-coloring postprocessing solution. Each of the plurality of ink head lines includes a plurality of ink heads. The plurality of ink heads is arranged side by side in the main scanning direction and eject inks for image formation respectively. The preprocessing head and the postprocessing head are arranged to satisfy a relationship of Formula 1 in a case where among the plurality of ink heads, the preprocessing head, and the postprocessing head, a head arranged closest to one end in the main scanning direction is defined as a one-end side head, a head arranged closest to another end is defined as an other-end side head, a distance from the one-end side head to the other-end side head in the main scanning direction is defined as LC, a distance from the one-end side head to the preprocessing head in the main scanning direction is defined as B1, and a distance from the one-end side head to the postprocessing head in the main scanning direction is defined as B2.

½≤(B1+B2)/LC≤3/2 (Formula 1)

According to the present configuration, it is possible to provide an all-in-one inkjet recording device in which three kinds of heads for ejecting the preprocessing solution, the ink, and the postprocessing solution are mounted on one carriage. In addition, since the preprocessing head, the ink head, and the postprocessing head are sequentially arranged in the conveyance direction, the preprocessing solution, the ink, and the postprocessing solution can be ejected to a recording medium in a desirable landing order. Furthermore, by appropriately arranging the preprocessing head and the postprocessing head so as to satisfy Formula 1, it is possible to reduce a variation in time from the landing of the preprocessing solution to the landing of the postprocessing solution regardless of a moving direction of the carriage. As a result, variations in image quality hardly occur on the recording medium.

In the above configuration, at least one of the preprocessing head and the postprocessing head may include a plurality of processing heads arranged side by side in the main scanning direction, at least one of the plurality of processing heads being arranged so as to satisfy the relationship of Formula 1.

According to this configuration, even when at least one of the preprocessing head and the postprocessing head is arranged in plural, arranging at least one of the processing heads so as to satisfy Formula 1 enables reduction in a variation in the time from the landing of the preprocessing solution to the landing of the postprocessing solution. In addition, since the processing solution can be further ejected from another processing head, an ejectable amount of the processing solution can be increased.

In the above configuration, all of the plurality of processing heads may be arranged to satisfy the relationship of Formula 1.

According to this configuration, by arranging all the plurality of processing heads of at least one of the preprocessing head and the postprocessing head so as to satisfy Formula 1, a variation in the time from the landing of the preprocessing solution to the landing of the postprocessing solution can be reduced, and an ejectable amount of the processing solution can be increased.

An inkjet recording device according to another aspect of the present disclosure includes a conveyance unit, a carriage, one ink head line or a plurality of ink head lines, a preprocessing head, and a postprocessing head. The conveyance unit is configured to convey a recording medium in a conveyance direction. The carriage is configured to reciprocate in a main scanning direction intersecting the conveyance direction. The one ink head line is located on the carriage at a position in the conveyance direction. The plurality of ink head lines includes an odd-numbered ink head lines. The plurality of ink head lines is located on the carriage to be aligned in the conveyance direction. The preprocessing head is arranged on an upstream side of the one or plurality of ink head lines in the conveyance direction and configured to eject a non-coloring preprocessing solution. The postprocessing head is arranged on a downstream side of the one or plurality of ink head lines in the conveyance direction and configured to eject a non-coloring postprocessing solution. Each of the one or plurality of ink head lines includes a plurality of ink heads. The plurality of ink heads is arranged side by side in the main scanning direction and is configured to eject inks for image formation respectively. The preprocessing head and the postprocessing head are arranged to satisfy a relationship of Formula 2 in a case where among the plurality of ink heads, the preprocessing head, and the postprocessing head, a head arranged closest to one end in the main scanning direction is defined as a one-end side head, a head arranged closest to another end is defined as an other-end side head, a distance from the one-end side head to the other-end side head in the main scanning direction is defined as LC, a distance from the one-end side head to the preprocessing head in the main scanning direction is defined as B1, and a distance from the one-end side head to the postprocessing head in the main scanning direction is defined as B2.

|(B1−B2)/LC|≤½ (Formula 2)

According to the present configuration, it is possible to provide an all-in-one inkjet recording device in which three kinds of heads for ejecting the preprocessing solution, the ink, and the postprocessing solution are mounted on one carriage. In addition, since the preprocessing head, the ink head, and the postprocessing head are sequentially arranged in the conveyance direction, the preprocessing solution, the ink, and the postprocessing solution can be ejected to a recording medium in a desirable landing order. Furthermore, by appropriately arranging the preprocessing head and the postprocessing head so as to satisfy Formula 2, it is possible to reduce a variation in the time from the landing of the preprocessing solution to the landing of the postprocessing solution regardless of the moving direction of the carriage. As a result, variations in image quality hardly occur on the recording medium. In addition to a normal case where the feed pitch of the recording medium is one head pitch, the above time variation can be reduced even in a case of 1/n head pitch (n is an odd number).

In the above configuration, at least one of the preprocessing head and the postprocessing head may include a plurality of processing heads arranged side by side in the main scanning direction, at least one of the plurality of processing heads being arranged to satisfy the relationship of Formula 2.

According to this configuration, even when at least one of the preprocessing head and the postprocessing head is arranged in plural, arranging at least one of the processing heads to satisfy Formula 2 enables reduction in a variation in the time from the landing of the preprocessing solution to the landing of the postprocessing solution. In addition, since the processing solution can be further ejected from another processing head, an ejectable amount of the processing solution can be increased.

In the above configuration, all of the plurality of processing heads may be arranged to satisfy the relationship of Formula 2.

According to this configuration, by arranging all the plurality of processing heads of at least one of the preprocessing head and the postprocessing head to satisfy Formula 2, a variation in the time from the landing of the preprocessing solution to the landing of the postprocessing solution can be reduced, and an ejectable amount of the processing solution can be increased.

In the above configuration, the preprocessing head and the postprocessing head may be arranged in a range of an arrangement width of the plurality of ink heads in the main scanning direction.

According to this inkjet recording device, even when the processing head is mounted on the carriage, it is not necessary to extend a width of the carriage in the main scanning direction. Accordingly, the width of the carriage in the main scanning direction can be reduced.

In the above configuration, at least one of the preprocessing head and the postprocessing head may be arranged to be partially interposed between a pair of adjacent ink heads in the main scanning direction among the plurality of ink heads included in the one ink head line.

According to this inkjet recording device, the ink heads and the processing heads arranged at different positions in the conveyance direction (sub-scanning direction) can be arranged at high density in the conveyance direction. Accordingly, a width of the carriage in the conveyance direction can be reduced.

In the above configuration, the preprocessing head and the postprocessing head may be arranged to be partially adjacent to the ink head in the main scanning direction and the conveyance direction, the plurality of ink heads may include a plurality of same color ink heads configured to eject inks of a same color, and for each of the same color ink heads, when the number of processing heads, of the preprocessing head and the postprocessing head, adjacent in the main scanning direction and the conveyance direction is counted, a difference between a maximum value and a minimum value of the count numbers may be one or less.

Generally, a head that ejects liquid by a jet method generates heat for pressurizing the liquid using electricity. In particular, unlike an ink head that performs ejection operation only when forming necessary color dots, a processing head that requires ejection operation corresponding to dots of all colors is likely to have a higher temperature. An ink head adjacent to such a processing head is likely to have a high temperature, and might have a larger difference in an ink ejection amount than that of an ink head not adjacent to the processing head. As described above, by setting, to one or less, the difference between the maximum value and the minimum value of the count number of the processing heads adjacent to each of the same color ink heads, a large difference in the ink ejection amount hardly occurs among the plurality of same color ink heads.

In the above configuration, the preprocessing head and the postprocessing head may be arranged so as to be partially adjacent to the ink head in the main scanning direction and the conveyance direction, the plurality of ink heads may include at least a first ink head that ejects ink of a first color and a second ink head that ejects ink of a second color, and when a total number of the preprocessing head and the postprocessing head adjacent to the first ink head is larger than a total number for the second ink head, the first ink head may eject, as the ink of the first color, ink having a smaller viscosity change caused by temperature than the ink of the second color.

According to this inkjet recording device, the first ink head having a large total number of adjacent processing heads ejects ink having a small viscosity change due to temperature. Accordingly, even when the first ink head is heated by the processing head, change of the ejection amount and the ejection speed of the ink of the first color caused by the temperature can be reduced.

In the above configuration, the preprocessing head and the postprocessing head may be arranged separately from the plurality of ink heads in the main scanning direction.

When the ink comes into contact with the processing solution, for example, an ink component might aggregate. In this case, when the aggregate adheres to an ink ejection nozzle of the ink head, an ejection failure might occur. According to the above inkjet recording device, since the processing head and the ink head are separately arranged in the main scanning direction, it is possible to make contact between the ink and the processing solution on the carriage hardly Occur.

In the above configuration, the carriage may include a first region in which the ink head lines are arranged and a second region adjacent to the first region in the main scanning direction, and the preprocessing head and the postprocessing head may be arranged in the second region.

According to this inkjet recording device, the preprocessing head and the postprocessing head, and the ink head can be arranged separately in the main scanning direction. Accordingly, it is possible to make it difficult for the preprocessing solution and the postprocessing solution to contact with the ink on the carriage, thereby making problems such as aggregation hardly occur.

In the above configuration, the preprocessing head and the postprocessing head may be arranged in a central region of an arrangement width of the ink head lines in the main scanning direction.

Alternatively, the preprocessing head and the postprocessing head may be arranged such that an arrangement or array center of one or a plurality of the preprocessing heads and an arrangement or array center of one or a plurality of the postprocessing heads in the main scanning direction coincide with each other in the main scanning direction.

According to these inkjet recording devices, it is possible to particularly reduce a variation in time from landing of the preprocessing solution on the recording medium to landing of the ink and a variation in time from landing of the ink to landing of the postprocessing solution at each main scanning position.

In the above inkjet recording device, of the preprocessing head and the postprocessing head, when a larger number of the heads is denoted as m and a smaller number of the heads is denoted as n, a requirement, m=n+odd number, may be satisfied, and the arrangement or array center of the preprocessing head and the postprocessing head may coincide with an arrangement position of one of the plurality of ink heads in the main scanning direction.

According to this inkjet recording device, the preprocessing head and the postprocessing head can be mounted on the carriages in a cluster to some extent. Thus, among the plurality of ink heads, the number of ink heads arranged at positions close to the processing head can be reduced. Accordingly, it is possible to reduce the possibility of contact of the preprocessing solution and the postprocessing solution with the ink on the carriage.

The above inkjet recording device may further include a holding member configured to hold the carriage in a state of being reciprocable in the main scanning direction, in which the carriage may include an engagement portion and may be held at the holding member in a cantilevered state by the engagement portion, and the preprocessing head may be arranged closer to the engagement portion than the postprocessing head in the conveyance direction.

According to this inkjet recording device, the carriage can be supported with a simple structure by causing the holding member to cantilever the carriage. In addition, cantilever support easily realizes a structure in which one side of the carriage is opened, and facilitates maintenance of the ink head and the processing head. When the carriage is cantilevered, it is assumed that the accuracy in the height direction decreases on the side of the carriage far from the engagement portion. However, since the postprocessing head having tolerance for a demand for ejection accuracy is mounted on the side far from the engagement portion, a great influence will be hardly exerted on image quality.

The above inkjet recording device may further include a holding member configured to hold the carriage in a state of being reciprocable in the main scanning direction, in which the carriage may include an engagement portion and is held at the holding member in a cantilevered state by the engagement portion, and of the preprocessing head and the postprocessing head, a processing head having a smaller number of heads may be arranged on an engagement portion side of the carriage.

As described above, the processing head generates heat by the ejection operation. For this reason, the carriage on which the processing head is mounted is heated, which may cause thermal deformation of the carriage and a holding structure thereof. In a mode in which the carriage is cantilevered, the thermal deformation might affect ink landing accuracy. According to the above configuration, the number of the processing heads arranged on the proximal end portion side can be reduced, and the influence of thermal deformation can be reduced.

The above inkjet recording device may further include a holding member configured to hold the carriage in a state of being reciprocable in the main scanning direction, in which the carriage may include an engagement portion and is held at the holding member in a cantilevered state by the engagement portion, and of the ink heads and the processing heads, a head arranged at a side closest to the engagement portion of the carriage may be arranged at a position excluding an end of a head array of the preprocessing head, the ink heads, and the postprocessing head in the main scanning direction.

According to this inkjet recording device, the head arranged on the side closest to the engagement portion is not arranged at the end of the head array (head arrangement region) in the main scanning direction. Generally, an end in the main scanning direction is closest to an end portion (corner) of the carriage. When thermal deformation occurs in the vicinity of the proximal end portion which is the end portion of the carriage, positional accuracy of the head mounted on the carriage decreases. The above configuration makes such problem hardly occur.

The above inkjet recording device may further include a plurality of ink sub-tanks configured to supply the ink to each of the plurality of ink heads of the ink head line; and a plurality of processing solution sub-tanks configured to supply one of the preprocessing solution and the postprocessing solution to each of the preprocessing head and the postprocessing head, the plurality of ink sub-tanks being located on the carriage to be aligned in the main scanning direction, and the plurality of processing solution sub-tanks being located on the carriage to be aligned in the main scanning direction at positions different from the plurality of ink sub-tanks in the conveyance direction.

According to the above configuration, since the ink sub-tank and the processing head sub-tank, similarly to the head, are arranged side by side in the main scanning direction and at different positions in the conveyance direction, the sub-tanks can be arranged in a relatively narrow range on the carriage. Acceleration in the main scanning direction acts on liquid in the sub-tank mounted on the carriage that reciprocates in the main scanning direction. Although the sub-tank and the head are connected by a predetermined pipeline, since when the sub-tanks are widely distributed on the carriage, an arrangement range of the pipeline in the main scanning direction also increases, the influence of the acceleration increases, so that meniscus breakdown might occur at an ejection portion of the head. The above configuration makes it possible to relatively narrow the arrangement range of the pipeline in the main scanning direction.

An inkjet recording method according to still another aspect of the present disclosure is an inkjet recording method of an inkjet recording device. The inkjet recording device includes a conveyance unit, a carriage, one ink head line or a plurality of ink head lines, a preprocessing head, and a postprocessing head. The conveyance unit conveys a recording medium in a predetermined conveyance direction. The carriage reciprocates in a main scanning direction intersecting the conveyance direction. The one ink head line is located on the carriage at a position in the conveyance direction. The plurality of ink head lines are located on the carriage and aligned in the conveyance direction. The preprocessing head is arranged on an upstream side of the one or plurality of ink head lines in the conveyance direction and configured to eject a non-coloring preprocessing solution. The postprocessing head is arranged on a downstream side of the one or plurality of ink head lines in the conveyance direction and configured to eject a non-coloring postprocessing solution. Each of the one or plurality of ink head lines includes a plurality of ink heads. The plurality of ink heads is arranged side by side in the main scanning direction and eject inks for image formation respectively. The inkjet recording method includes: arranging the preprocessing head and the postprocessing head to satisfy a relationship of Formula 1 in a case where among the plurality of ink heads, the preprocessing head, and the postprocessing head, a head arranged closest to one end in the main scanning direction is defined as a one-end side head, a head arranged closest to another end is defined as an other-end side head, a distance from the one-end side head to the other-end side head in the main scanning direction is defined as LC, a distance from the one-end side head to the preprocessing head in the main scanning direction is defined as B1, and a distance from the one-end side head to the postprocessing head in the main scanning direction is defined as B2, ½≤(B1+B2)/LC≤3/2 . . . (Formula 1); ejecting the preprocessing solution from the preprocessing head to a predetermined recording region on the recording medium while moving the carriage in a first direction in the main scanning direction; feeding the recording medium in the conveyance direction, and ejecting the ink from the ink head to the recording region received the ejected preprocessing solution while moving the carriage in the main scanning direction; and further feeding the recording medium in the conveyance direction, and ejecting the postprocessing solution from the postprocessing head to the recording region received the ejected ink while moving the carriage in a second direction opposite to the first direction in the main scanning direction.

According to the present method, it is possible to efficiently form an image on a recording medium by the all-in-one inkjet recording device in which heads for ejecting the preprocessing solution, the ink, and the postprocessing solution are all mounted on one carriage. In particular, since the preprocessing head, the ink head, and the postprocessing head are sequentially arranged in the conveyance direction, the preprocessing solution, the ink, and the postprocessing solution can be landed on the recording medium in a desirable landing order. Furthermore, the preprocessing head and the postprocessing head are appropriately arranged to satisfy Formula 1, and the preprocessing head and the postprocessing head eject the processing solutions to a predetermined recording region while being moved in the directions opposite to each other in the main scanning direction, so that a variation of the time from the landing of the preprocessing solution to the landing of the postprocessing solution can be reduced. As a result, variations in image quality hardly occur on the recording medium.

In particular, according to the above method, a variation in time from the landing of the preprocessing solution to the landing of the postprocessing solution can be reduced in a case where even-numbered ink head lines of the ink heads are provided in the conveyance direction, or in a case where odd-numbered ink head lines of the ink heads are provided in the conveyance direction F, and the feed pitch of the recording medium is 1/n head pitch (n is an even number).

Further, an inkjet recording method according to still another aspect of the present disclosure is an inkjet recording method of an inkjet recording device. The inkjet recording device includes a conveyance unit, a carriage, one ink head line or a plurality of ink head lines, a preprocessing head, and a postprocessing head. The conveyance unit conveys a recording medium in a conveyance direction. The carriage reciprocates in a main scanning direction intersecting the conveyance direction. The one ink head line is located on the carriage at a position in the conveyance direction. The plurality of ink head lines are located on the carriage to be aligned in the conveyance direction. The preprocessing head is arranged on an upstream side of the one or plurality of ink head lines in the conveyance direction and configured to eject a non-coloring preprocessing solution. The postprocessing head is arranged on a downstream side of the one or plurality of ink head lines in the conveyance direction and configured to eject a non-coloring postprocessing solution. Each of the one or plurality of ink head lines includes a plurality of ink heads. The plurality of ink heads is arranged side by side in the main scanning direction and is configured to eject inks for image formation respectively. The inkjet recording method includes: arranging the preprocessing head and the postprocessing head to satisfy a relationship of Formula 2 in a case where among the plurality of ink heads, the preprocessing head, and the postprocessing head, a head arranged closest to one end in the main scanning direction is defined as a one-end side head, a head arranged closest to another end is defined as an other-end side head, a distance from the one-end side head to the other-end side head in the main scanning direction is defined as LC, a distance from the one-end side head to the preprocessing head in the main scanning direction is defined as B1, and a distance from the one-end side head to the postprocessing head in the main scanning direction is defined as B2, |(B1−B2)/LC|≤½ . . . (Formula 2); ejecting the preprocessing solution from the preprocessing head to a recording region on the recording medium while moving the carriage in a first direction in the main scanning direction; feeding the recording medium in the conveyance direction, and ejecting the ink from the ink head to the recording region received the ejected preprocessing solution while moving the carriage in the main scanning direction; and further feeding the recording medium in the conveyance direction, and ejecting the postprocessing solution from the postprocessing head to the recording region received the ejected ink while moving the carriage in the first direction in the main scanning direction.

According to the present method, it is possible to efficiently form an image on a recording medium by the all-in-one inkjet recording device in which three kinds of heads for ejecting the preprocessing solution, the ink, and the postprocessing solution are mounted on one carriage. In particular, since the preprocessing head, the ink head, and the postprocessing head are sequentially arranged in the conveyance direction, the preprocessing solution, the ink, and the postprocessing solution can be ejected to the recording medium in a desirable landing order. Furthermore, the preprocessing head and the postprocessing head are appropriately arranged so as to satisfy Formula 2, and the preprocessing head and the postprocessing head eject the processing solutions while being moved in the same direction in the main scanning direction, so that a variation of the time from the landing of the preprocessing solution to the landing of the postprocessing solution can be reduced. As a result, variations in image quality hardly occur on the recording medium.

In particular, according to the above method, a variation in time from the landing of the preprocessing solution to the landing of the postprocessing solution can be reduced in a case where odd-numbered ink head lines of the ink heads are provided in the conveyance direction, and the feed pitch of the recording medium is one head pitch or 1/n head pitch (n is an odd number).

According to the present disclosure, it is possible to provide an inkjet recording device that includes a carriage on which a preprocessing head, an ink head, and a postprocessing head are mounted and which moves in a main scanning direction, and that enables reduction of a variation in time from landing of a preprocessing solution to landing of a postprocessing solution, and an inkjet recording method thereof.

### REFERENCE SIGNS

1 inkjet printer (ink head type recording device)
16 timing belt (moving member)
17 guide rail (holding member)
20 workpiece conveyance unit (conveyance unit)
3, 3A to 3J carriage
31 head support frame
32 back frame (engagement portion)
4 ink head
41 first ink head line (ink head line)
42 second ink head line (ink head line)
43 third ink head line (ink head line)
4A to 4F first to sixth ink heads
4A1 to 4F1 upstream side head
4A2 to 4F2 downstream side head
5 preprocessing head (processing head)
6 postprocessing head (processing head)
7 sub-tank
7A to 7F ink sub-tank
71 preprocessing solution sub-tank
72 postprocessing solution sub-tank
F conveyance direction
S main scanning direction
W workpiece (recording medium)

1. An inkjet recording device, comprising:
a conveyance unit configured to convey a recording medium in a conveyance direction;
a carriage configured to reciprocate in a main scanning direction intersecting the conveyance direction;
a plurality of ink head lines, including an even-numbered ink head lines, located on the carriage and aligned in the conveyance direction;
a preprocessing head arranged on an upstream side of the plurality of ink head lines in the conveyance direction and configured to eject a non-coloring preprocessing solution; and
a postprocessing head arranged on a downstream side of the plurality of ink head lines in the conveyance direction and configured to eject a non-coloring postprocessing solution, wherein
each of the plurality of ink head lines includes a plurality of ink heads, wherein the plurality of ink heads is arranged side by side in the main scanning direction and is configured to eject inks for image formation respectively, and
the preprocessing head and the postprocessing head are arranged to satisfy a relationship of Formula 1 in a case where among the plurality of ink heads, the preprocessing head, and the postprocessing head, a head arranged closest to one end in the main scanning direction is defined as a one-end side head, a head arranged closest to another end is defined as an other-end side head, a distance from the one-end side head to the other-end side head in the main scanning direction is defined as LC, a distance from the one-end side head to the preprocessing head in the main scanning direction is defined as B1, and a distance from the one-end side head to the postprocessing head in the main scanning direction is defined as B2.
½≤(B1+B2)/LC≤3/2 (Formula 1)

2. The inkjet recording device according to claim 1, wherein at least one of the preprocessing head and the postprocessing head includes a plurality of processing heads arranged side by side in the main scanning direction, at least one of the plurality of processing heads being arranged to satisfy the relationship of the Formula 1.

3. The inkjet recording device according to claim 2, wherein all of the plurality of processing heads are arranged to satisfy the relationship of the Formula 1.

4. An inkjet recording device, comprising:
a conveyance unit configured to convey a recording medium in a conveyance direction;
a carriage configured to reciprocate in a main scanning direction intersecting the conveyance direction;
one ink head line located on the carriage at a position in the conveyance direction or a plurality of ink head lines, including an odd-numbered ink head lines, located on the carriage to be aligned in the conveyance direction;
a preprocessing head arranged on an upstream side of the one or plurality of ink head lines in the conveyance direction and configured to eject a non-coloring preprocessing solution; and
a postprocessing head arranged on a downstream side of the one or plurality of ink head lines in the conveyance direction and configured to eject a non-coloring postprocessing solution, wherein
each of the one or plurality of ink head lines includes a plurality of ink heads, wherein the plurality of ink heads is arranged side by side in the main scanning direction and is configured to eject inks for image formation respectively, and
the preprocessing head and the postprocessing head are arranged to satisfy a relationship of Formula 2 in a case where among the plurality of ink heads, the preprocessing head, and the postprocessing head, a head arranged closest to one end in the main scanning direction is defined as a one-end side head, a head arranged closest to another end is defined as an other-end side head, a distance from the one-end side head to the other-end side head in the main scanning direction is defined as LC, a distance from the one-end side head to the preprocessing head in the main scanning direction is defined as B1, and a distance from the one-end side head to the postprocessing head in the main scanning direction is defined as B2.

|(B1−B2)/LC|≤½ (Formula 2)

5. The inkjet recording device according to claim 4, wherein at least one of the preprocessing head and the postprocessing head includes a plurality of processing heads arranged side by side in the main scanning direction, at least one of the plurality of processing heads being arranged to satisfy the relationship of the Formula 2.

6. The inkjet recording device according to claim 1, wherein the preprocessing head and the postprocessing head are arranged in a range of an arrangement width of the plurality of ink heads in the main scanning direction.

7. The inkjet recording device according to claim 1, wherein at least one of the preprocessing head and the postprocessing head is arranged to be partially interposed between a pair of adjacent ink heads in the main scanning direction among the plurality of ink heads included in the one ink head line.

8. The inkjet recording device according to claim 1, wherein
the preprocessing head and the postprocessing head are arranged to be partially adjacent to the ink head in the main scanning direction and the conveyance direction,
the plurality of ink heads include a plurality of same color ink heads configured to eject inks of a same color, and
for each of the same color ink heads, when the number of processing heads, of the preprocessing head and the postprocessing head, adjacent in the main scanning direction and the conveyance direction is counted, a difference between a maximum value and a minimum value of the count numbers is one or less.

9. The inkjet recording device according to claim 1, wherein
the preprocessing head and the postprocessing head are arranged to be partially adjacent to the ink head in the main scanning direction and the conveyance direction,
the plurality of ink heads include at least a first ink head configured to eject ink of a first color and a second ink head configured to eject ink of a second color, and
when a total number of the preprocessing head and the postprocessing head adjacent to the first ink head is larger than a total number for the second ink head, the first ink head ejects, as the ink of the first color, ink having a smaller viscosity change caused by temperature than the ink of the second color.

10. The inkjet recording device according to claim 1, wherein the preprocessing head and the postprocessing head are arranged separately from the plurality of ink heads in the main scanning direction.

11. The inkjet recording device according to claim 1, wherein
the carriage includes a first region and a second region adjacent to the first region in the main scanning direction, the ink head lines being arranged in the first region, and
the preprocessing head and the postprocessing head are arranged in the second region.

12. The inkjet recording device according to claim 1, wherein the preprocessing head and the postprocessing head are arranged in a central region of an arrangement width of the ink head lines in the main scanning direction.

13. The inkjet recording device according to claim 1, wherein the preprocessing head and the postprocessing head are arranged such that an arrangement or array center of one or a plurality of the preprocessing heads and an arrangement or array center of one or a plurality of the postprocessing heads in the main scanning direction coincide with each other in the main scanning direction.

14. The inkjet recording device according to claim 13, wherein
of the preprocessing head and the postprocessing head, when a larger number of the heads is denoted as m and a smaller number of the heads is denoted as n, a requirement, m=n+odd number, is satisfied, and
the arrangement or array center of the preprocessing head and the postprocessing head coincides with an arrangement position of one of the plurality of ink heads in the main scanning direction.

15. The inkjet recording device according to claim 1,
further comprising a holding member configured to hold the carriage in a state of being reciprocable in the main scanning direction, wherein
the carriage includes an engagement portion and is held at the holding member in a cantilevered state by the engagement portion, and
the preprocessing head is arranged closer to the engagement portion than the postprocessing head in the conveyance direction.

16. The inkjet recording device according to claim 1,
further comprising a holding member configured to hold the carriage in a state of being reciprocable in the main scanning direction, wherein
the carriage includes an engagement portion and is held at the holding member in a cantilevered state by the engagement portion, and
of the preprocessing head and the postprocessing head, a processing head having a smaller number of heads is arranged on an engagement portion side of the carriage.

17. The inkjet recording device according to claim 1,
further comprising a holding member configured to hold the carriage in a state of being reciprocable in the main scanning direction, wherein
the carriage includes an engagement portion and is held at the holding member in a cantilevered state by the engagement portion, and
of the preprocessing head and the postprocessing head, a head arranged at a side closest to the engagement portion of the carriage is arranged at a position excluding an end of a head array of the preprocessing head, the ink heads, and the postprocessing head in the main scanning direction.

18. The inkjet recording device according to claim 1,
further comprising a plurality of ink sub-tanks configured to supply the ink to each of the plurality of ink heads of the ink head line; and a plurality of processing solution sub-tanks configured to supply one of the preprocessing solution and the postprocessing solution to each of the preprocessing head and the postprocessing head, wherein
the plurality of ink sub-tanks is located on the carriage to be aligned in the main scanning direction, and
the plurality of processing solution sub-tanks is located on the carriage and aligned in the main scanning direction at positions different from the plurality of ink sub-tanks in the conveyance direction.

19. An inkjet recording method of an inkjet recording device, the inkjet recording device including:
a conveyance unit configured to convey a recording medium in a conveyance direction;
a carriage configured to reciprocate in a main scanning direction intersecting the conveyance direction;
one ink head line located on the carriage at a position in the conveyance direction or a plurality of ink head lines located on the carriage and aligned in the conveyance direction;
a preprocessing head arranged on an upstream side of the one or plurality of ink head lines in the conveyance direction and configured to eject a non-coloring preprocessing solution; and
a postprocessing head arranged on a downstream side of the one or plurality of ink head lines in the conveyance direction and configured to eject a non-coloring postprocessing solution,
wherein each of the one or plurality of ink head lines includes a plurality of ink heads, wherein the plurality of ink heads is arranged side by side in the main scanning direction and is configured to eject inks for image formation respectively,
the inkjet recording method comprising:
arranging the preprocessing head and the postprocessing head to satisfy a relationship of Formula 1 in a case where among the plurality of ink heads, the preprocessing head, and the postprocessing head, a head arranged closest to one end in the main scanning direction is defined as a one-end side head, a head arranged closest to another end is defined as an other-end side head, a distance from the one-end side head to the other-end side head in the main scanning direction is defined as LC, a distance from the one-end side head to the preprocessing head in the main scanning direction is defined as B1, and a distance from the one-end side head to the postprocessing head in the main scanning direction is defined as B2,
½≤(B1+B2)/LC≤3/2 (Formula 1);
ejecting the preprocessing solution from the preprocessing head to a recording region on the recording medium while moving the carriage in a first direction in the main scanning direction;
feeding the recording medium in the conveyance direction, and ejecting the ink from the ink head to the recording region received the ejected preprocessing solution while moving the carriage in the main scanning direction; and
further feeding the recording medium in the conveyance direction, and ejecting the postprocessing solution from the postprocessing head to the recording region received the ejected ink while moving the carriage in a second direction opposite to the first direction in the main scanning direction.

20. An inkjet recording method of an inkjet recording device, the inkjet recording device including:
a conveyance unit configured to convey a recording medium in a conveyance direction;
a carriage configured to reciprocate in a main scanning direction intersecting the conveyance direction;
one ink head line located on the carriage at a position in the conveyance direction or a plurality of ink head lines located on the carriage to be aligned in the conveyance direction;
a preprocessing head arranged on an upstream side of the one or plurality of ink head lines in the conveyance direction and configured to eject a non-coloring preprocessing solution; and
a postprocessing head arranged on a downstream side of the one or plurality of ink head lines in the conveyance direction and configured to eject a non-coloring postprocessing solution,
wherein each of the one or plurality of ink head lines including a plurality of ink heads, wherein a plurality of ink heads is arranged side by side in the main scanning direction and is configured to eject inks for image formation respectively,
the inkjet recording method comprising:
arranging the preprocessing head and the postprocessing head to satisfy a relationship of Formula 2 in a case where among the plurality of ink heads, the preprocessing head, and the postprocessing head, a head arranged closest to one end in the main scanning direction is defined as a one-end side head, a head arranged closest to another end is defined as an other-end side head, a distance from the one-end side head to the other-end side head in the main scanning direction is defined as LC, a distance from the one-end side head to the preprocessing head in the main scanning direction is defined as B1, and a distance from the one-end side head to the postprocessing head in the main scanning direction is defined as B2,

|(B1−B2)/LC|≤½ (Formula 2);
ejecting the preprocessing solution from the preprocessing head to a recording region on the recording medium while moving the carriage in a first direction in the main scanning direction;
feeding the recording medium in the conveyance direction, and ejecting the ink from the ink head to the recording region received the ejected preprocessing solution while moving the carriage in the main scanning direction; and
further feeding the recording medium in the conveyance direction, and ejecting the postprocessing solution from the postprocessing head to the recording region received the ejected ink while moving the carriage in the first direction in the main scanning direction.
